(19) United States
(12) Patent Application Publication
(10) Pub. No.: US 2016/0307146 A1
(43) Pub. Date: Oct. 20, 2016

(54) RULE COMPRESSION IN MEAN FIELD SYSTEM

(71) Applicant: Microsoft Technology Licensing, LLC, Redmond, WA (US)

(72) Inventors: Rekha Nanda, Redmond, WA (US); Yanfang Shen, Bellevue, WA (US); Malvika K. Pimple, Bellevue, WA (US); Wolf Kohn, Seattle, WA (US)

(21) Appl. No.: 14/940,939

(22) Filed: Nov. 13, 2015

Related U.S. Application Data
(63) Continuation-in-part of application No. 14/689,451, filed on Apr. 17, 2015.

(51) Int. Cl. G06Q 10/08

(52) U.S. Cl. CPC G06Q 10/087

(57) ABSTRACT

A set of conditional rules (or transformations) that are effective for an article under analysis is identified. The set of rules is compressed into a single rule which is applied to a first quantity identifier that identifies a first quantity of the article, to obtain a second quantity. An order generation system generates an order based on the second quantity.

### CROSS-REFERENCE TO RELATED APPLICATION

The present application is based on and claims the benefit of U.S. patent application Ser. No. 14/689,451, filed Apr. 17, 2015, the content of which is hereby incorporated by reference in its entirety.

### BACKGROUND

Computer systems are currently in wide use. Many computer systems use models to generate actionable outputs.

By way of example, some computer systems include systems used by organizations to accomplish the work of the organization. Such systems can include, for instance, customer relations management (CRM) systems, enterprise resource planning (ERP) systems, line-of-business (LOB) systems, among others. These types of systems sometimes attempt to model various processes and phenomena that occur in conducting the business of an organization that deploys the system.

Such models can be relatively complicated. For instance, some organizations may sell millions of different variations of different products. Each product can be represented by a stock keeping unit (SKU). By way of example, a department store may sell shoes. There, may be hundreds of different styles of shoes, each of which comes in many different sizes, many different colors, etc.

It can be difficult to manage these large volume. Conventional dynamic programming and optimal control methods are often viewed as being impractical to solve such large scale problems. This can be especially true when items, such as SKUs, are not independent. These conventional methods are not scalable to large numbers of SKUs, because it is often impractical to construct and update correlation functions that represent the correlations between the different SKUs.

The discussion above is merely provided for general background information and is not intended to be used as an aid in determining the scope of the claimed subject matter.

### SUMMARY

A set of conditional rules (or transformations) that are effective for an article under analysis is identified. The set of rules is compressed into a single rule which is applied to a first quantity identifier that identifies a first quantity of the article, to obtain a second quantity. An order generation system generates an order based on the second quantity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a forecasting architecture.

FIG. 2 is a block diagram showing one example of a forecast system (shown in FIG. 1) in more detail.

FIG. 3 is a flow diagram illustrating one example of the operation of the forecast system shown in FIG. 2.

FIG. 4 is a block diagram showing one example of a demand forecaster and order suggestion generator (shown in FIG. 2) in more detail.

FIG. 5 is a block diagram showing one example of a cluster deconstruction component (shown in FIG. 3) in more detail.

FIG. 6 is a flow diagram illustrating one example of the operation of the cluster deconstruction component shown in FIG. 5.

FIG. 7 is a block diagram of one example of a portion of an interrogation system.

FIG. 8 is a flow diagram of one example of the operation of the interrogation system.

FIG. 9 is a block diagram of an example of a portion of the interrogation system.

FIG. 10 is a flow diagram of one example of the operation of the interrogation system.

FIG. 11 is a block diagram of one example of an optimization system.

FIG. 12 is a block diagram of one example of a rule (or transformation).

FIGS. 13A-13C are examples of user interface displays.

FIG. 14 is a flow diagram showing one example of the operation of the operation of the optimization system.

FIG. 15 is a flow diagram showing one example of the operation of a rule compression system.

FIG. 16 is a block diagram showing one example of the architecture illustrated in FIG. 1, deployed in a cloud computing architecture.

FIG. 17 is a block diagram of one example of a computing environment.

### DETAILED DESCRIPTION

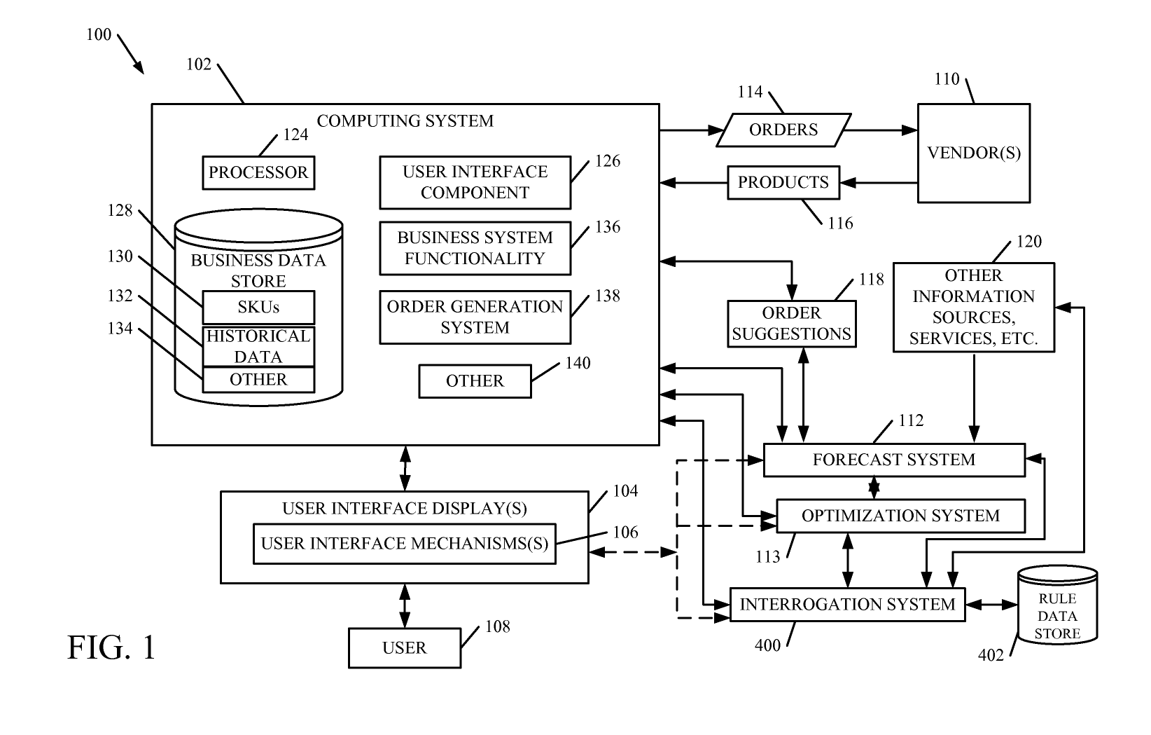

FIG. 1 is a block diagram of one example of a forecasting architecture 100, deployed in conjunction with a computing system (such as a business system) 102. Business system 102 illustratively generates user interface displays 104 with user input mechanisms 106 for interaction by user 108. User 108 illustratively interacts with user input mechanisms 106 in order to control and manipulate business system 102, so that user 108 can perform his or her tasks or activities for the organization that uses business system 102.

Architecture 100 also illustratively shows that business system 102 communicates with one or more vendors 110 and can also communicate with forecast system 112 and optimization system 113. By way of example, business system 102 can generate and send orders 114 for various products 116, to vendors 110. Those vendors then illustratively send the products 116 to business system 102, where they are sold, consumed, or otherwise disposed of.

In the example shown in FIG. 1, business system 102 can receive order suggestions 118 from forecast system 112 and optimization system 113. In the example illustrated in FIG. 1, forecast system 112 illustratively obtains historical data from business system 102 and generates a model that can be used to generate forecasts, of different types, for use in providing order suggestions 118 to business system 102. Optimization system 113 can also obtain information from user 108 and provide a modified (e.g., optimized) set of order suggestions based on that information. It will be noted, of course, that order suggestions 118 are only one type of information that can be provided by forecast system 112. System 112 can provide other forecasts, of different types, for use in business system 102. It can provide demand forecasts, or a variety of other information that can be used by a wide variety of systems, such as inventory control systems, purchasing systems, assortment planning systems, among a wide variety of others.

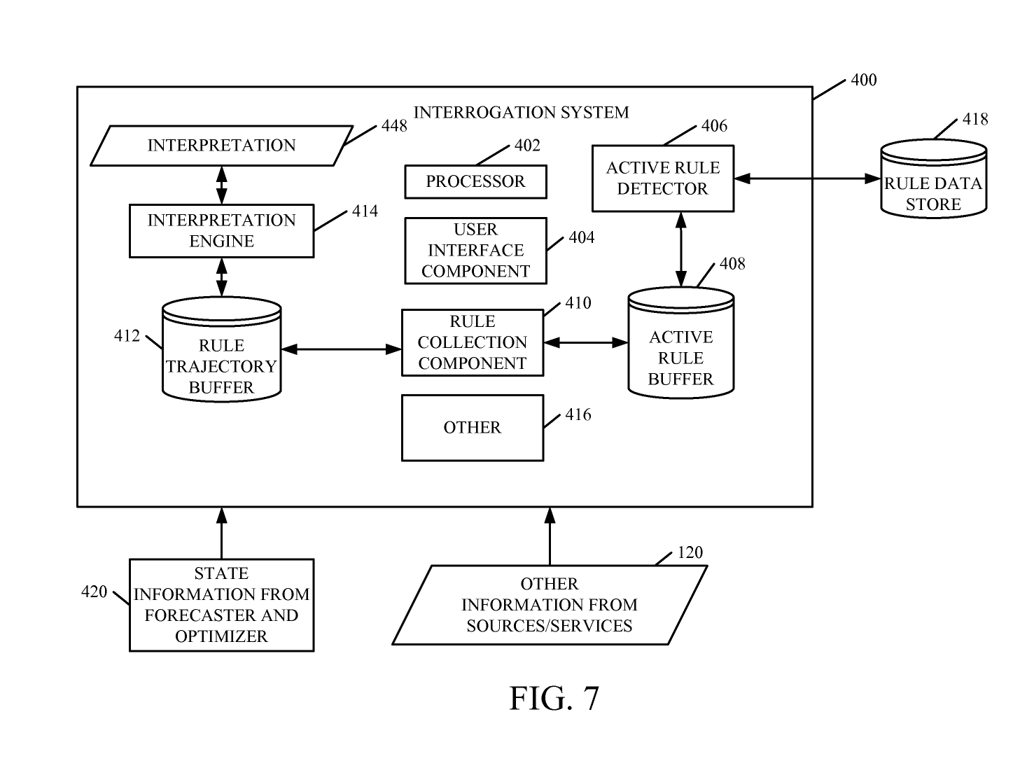

FIG. 1 also shows that user 108 can use interrogation system 400 (either directly or through computing system 102 or otherwise) to obtain information indicative of rules in data store 402 that were active and effective in generating the order suggestions 118. This is described in greater detail below with respect to FIGS. 7-10.

In the example described herein, forecast system 112 illustratively generates a demand forecast (as is described in greater detail below) that can be used to suggest orders (in order suggestions 118) for business system 102. Optimization system 113 can receive additional information (such as from user 108 or elsewhere) and optimize the order suggestions based on that information. Business system 102 can use order suggestions 118 (or optimized order suggestions) in generating purchase orders 114 for submission to vendors 110, in order to obtain products 116 that are used as inventory at business system 102.

FIG. 1 also shows that, in one example, forecast system 112 and optimization system 113 not only obtain information from business system 102 (such as historical sales information, etc.) but they can obtain other information from other sources or services 120. For example, where forecast system 112 is forecasting product demand, it may include weather forecast information from weather forecast sources or services. By way of example, it may be that the demand forecast for summer clothing may be influenced by the weather forecast or other information. In another example, it may be that vendors 110 only ship products on a periodic basis (such as on the 15^{th} of the month, every other Tuesday, etc.). This information can also be obtained by forecast system 112 in order to identify a timing when orders should be placed. The timing can be output as part of order suggestions 118 as well. These are but two examples of the different types of information that can be considered by forecast system 112, and it can consider other types of information as well.

In the example shown in FIG. 1, business system 102 illustratively includes processor 124, user interface component 126, business data store 128 (which, itself, stores SKUs 130 that represent the various products used or sold by the organization that uses business system 102, as well time-indexed historical data 132—which, itself, can include demand information, inventory information, ordering information, receipt information, etc.—and it can include other information 134 as well), business system functionality 136, order generation system 138, and it can include other items 140. Before describing one example of the operation of architecture 100 in more detail, a brief overview of some of the items shown in architecture 100 will first be provided.

In the example illustrated, business system functionality 136 is illustratively functionality employed by business system 102 that allows user 108 to perform his or her tasks or activities in conducting the business of the organization that uses system 102. For instance, where user 108 is a sales person, functionality 136 allows user 108 to perform workflows, processes, activities and tasks in order to conduct the sales business of the organization. The functionality can include applications that are run by an application component. The applications can be used to run processes and workflows in business system 102 and to generate various user interface displays 104 that assist user 108 in performing his or her activities or tasks.

Order generation system 136 illustratively provides functionality that allows user 108 to view the order suggestions 118 provided by forecast system 112 (along with any other information relevant to generating orders). It can also provide functionality so user 108 can generate purchase orders 114 based upon that information, or so the purchase orders 114 can be automatically generated.

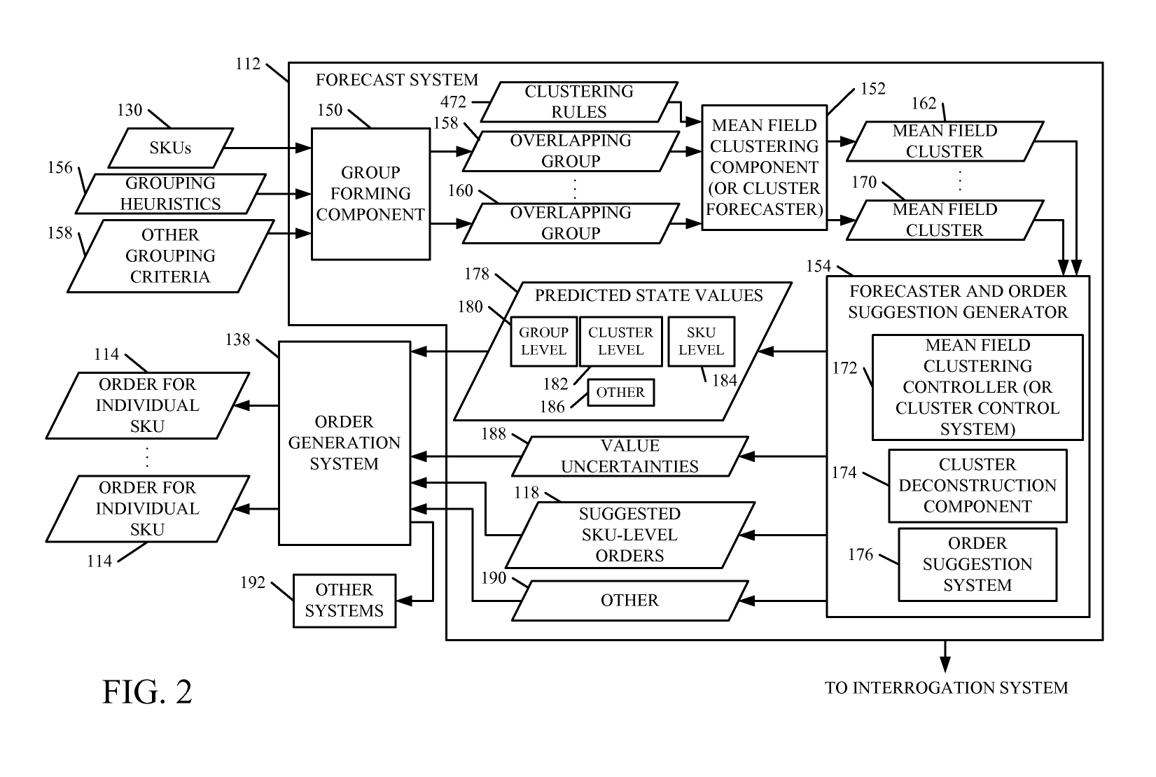

FIG. 2 is a block diagram showing one example of forecast system 112 in more detail. FIG. 2 shows that forecast system 112 illustratively includes group forming component 150, Mean Field clustering component (or cluster forecaster) 152 and forecaster and order suggestion generator 154. FIG. 2 also shows that, in one example, forecast system 112 illustratively receives SKUs 130 from business system 102. It can also receive a set of grouping heuristics, or rules, 156, and it can receive other grouping criteria 158. FIG. 2 also shows that forecaster and order suggestion generator 154 provides outputs to order generation system 138 where that information can be used (by system 138 and user 108) in order to generate a set of purchase orders 114 for individual SKUs.

Before describing the overall operation of forecast system 112 in more detail, a brief overview will first be provided. Group forming component 150 illustratively first divides the SKUs 130 into overlapping groups 158-160. Mean Field clustering component 152 divides the SKUs within the overlapping groups 158-160 into a set of Mean Field clusters 162-170 and provides them to forecaster and order suggestion generator 154. Forecaster and order suggestion generator 154 illustratively includes Mean Field cluster controller (or cluster control system) 172, cluster deconstruction component 174 and order suggestions system 176. Mean Field cluster controller 172 generates a set of decisions for a tracker (or sensor) representing each Mean Field cluster 162-170. Cluster deconstruction component 174 then deconstructs those decisions to generate a corresponding decision for each particle (or member) of the corresponding Mean Field cluster. This information is provided to order suggestion system 176 that generates suggested orders 118.

It will be noted that, in the example shown in FIG. 2, forecaster and order suggestion generator 154 can provide additional information as well. For instance, it can provide predicted state values 178 for the various controller states. These values can be at the group level 180, at the cluster level 182, at the individual SKU level 184, or at other levels 186. It can also provide value uncertainties 188, corresponding to the predicted state values 178. It can provide other information 190 as well.

The information is shown being provided to order generation system 138 for use in generating purchase orders 114. It will also be noted, of course, that the information can be provided to other systems 192. For instance, it can be stored in business data store 128 as additional historical data 132. It can be provided to other analysis systems for trend analysis, assortment planning, inventory control, or a wide variety of other systems as well.

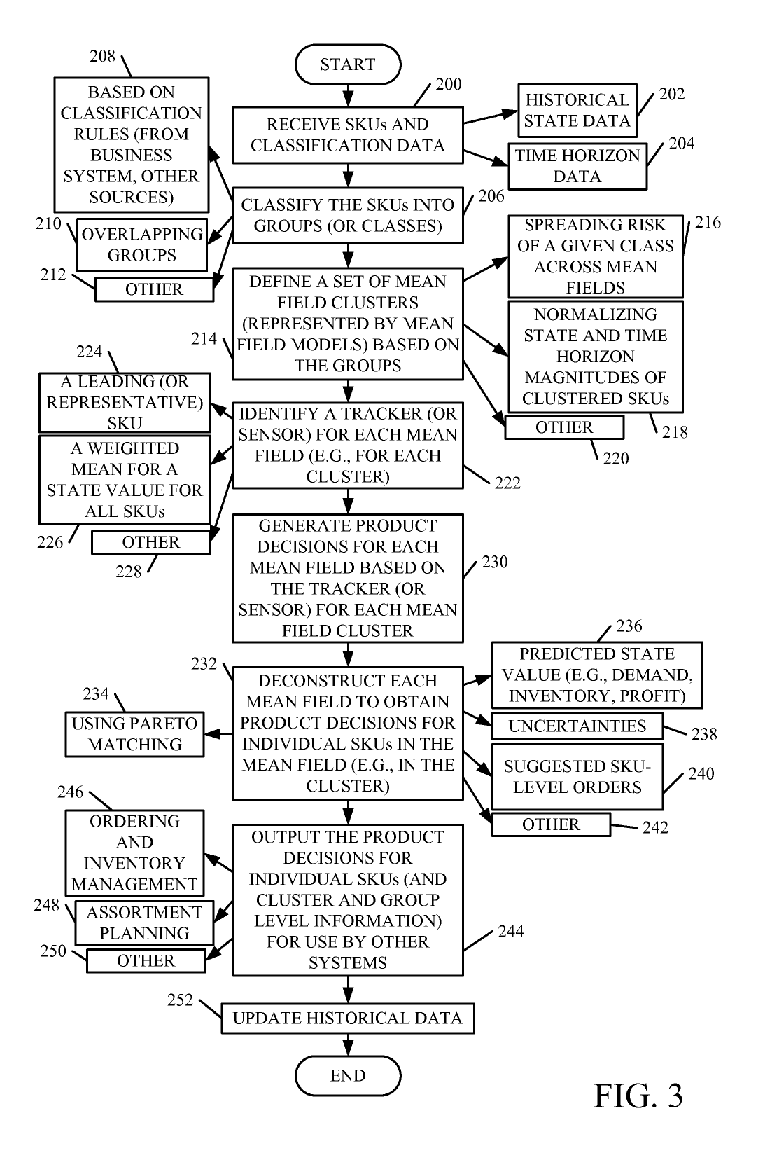

FIG. 3 is a flow diagram illustrating one example of the operation of forecast system 112 in more detail. FIGS. 1-3 will now be described in conjunction with one another. It should also be noted that a more formal description of the operation of forecast system 112 is provided below.

Forecast system 112 first receives the set of SKUs 130, along with classification or grouping data (such as grouping heuristics or rules 156 or other grouping criteria 158) from business system 102. This is indicated by block 200 in FIG. 3. The information can also include historical state data 202, as well as time horizon data 204. In one example, for instance, where forecast system 112 forecasts demand, it also considers inventory and profit. Thus, the state values that are received, per SKU, can include demand, demand uncertainty, inventory, inventory uncertainty, profit, profit uncertainty, and order information.

Group forming component 150 illustratively classifies the SKUs 130 into groups (or classes). This is indicated by block 206. This can be done using classification rules (which can be provided from business system 102 or other sources 120). This is indicated by block 208. The classification rules can be functions of the state values, the time horizon, or other variables used by group forming component (or classifier) 150. One example of rules that component 150 can use to classify SKUs 130 into groups 158-160 can include the range of average demand.

In one example, the groups are overlapping groups 210. For instance, the groups illustratively include SKU membership that overlaps along the edges between two adjacent groups (or classes). By way of example, component 150 can classify SKUs with average demand between 10 and 100 into one group 158, and SKUs with average demand between 90 and 200 into another group 160. Thus, the two groups have an overlap in membership. Component 150 can classify the SKUs in other ways as well, and this is indicated by block 212.

Mean Field clustering component 152 then defines a set of Mean Field clusters (which can be represented by Mean Field models) based upon the overlapping groups 158-160 and clustering rules 472. In the example shown in FIG. 2, the clusters are represented by blocks 162-170. Defining the set of Mean Field clusters is indicated by block 214 in FIG. 3. The Mean Field clusters 162-170 contain SKUs that are measured as similar under a predetermined metric. For example, the weighted demand of the SKUs in each cluster may be similar.

It can thus be seen that each cluster 162-170 is a Mean Field which has its own Mean Field dynamics Thus, a forecaster, controller, etc., that can be designed for a single SKU can be applied directly to each Mean Field.

Mean Fields are generated instead of simply processing groups 158-160 based on rules 472. For instance, rules 472 can be configured in order to spread the risk or uncertainty of each group 158-160 into multiple different Mean Fields. Spreading the risk in this way is indicated by block 216. As an example, if a group 158 represents all iced tea products and that group is defined directly as a Mean Field, then if the performance of the Mean Field dynamics is relatively poor for that group, a store that bases its purchase orders of iced tea on those dynamics may run out of all iced tea. However, if the SKUs for the iced tea products are spread into different Mean Field clusters 162-170, and each cluster is a Mean Field, then if the Mean Field dynamics for one cluster operates poorly, it does not cause the whole group, representing all iced tea products to suffer. For instance, by spreading the uncertainty in this way, a store using the Mean Field dynamics to generate purchase orders may run out of one or more brands of iced tea (those that have SKUs in the poorly performing Mean Field cluster), but there may still be other brands of iced tea available (those that have SKUs in a different Mean Field cluster). Thus, the risk of each group or class 158-160 is spread across multiple different Mean Fields 162-170.

In addition, in order to group SKUs from different overlapping groups 158-160 into a single Mean Field cluster (such as cluster 162) the information corresponding to the individual SKUs is illustratively normalized. For instance, the magnitude of the state and time horizon (or other variables) of the grouped SKUs are illustratively normalized. This is indicated by block 218. The set of Mean Field clusters can be defined in other ways as well, and this is indicated by block 220.

Mean Field clustering component 152 also illustratively identifies a tracker (or sensor) that represents each Mean Field cluster. This is indicated by block 222 in FIG. 3. By way of example, the sensor or tracker for each Mean Field can be a leading (or representative) SKU in Mean Field cluster that captures the performance of the membership of the Mean Field cluster relatively well. This is indicated by block 224. The tracker or sensor can also be a weighted mean for a state value for all SKUs in the Mean Field cluster. This is indicated by block 226. The tracker or sensor can be other values as well, and this is indicated by block 228.

A Mean Field cluster controller 172 is then generated for each Mean Field cluster 162-170, and it is used to generate product decisions for each Mean Field, based upon the particular tracker, or sensor. This is indicated by block 230.

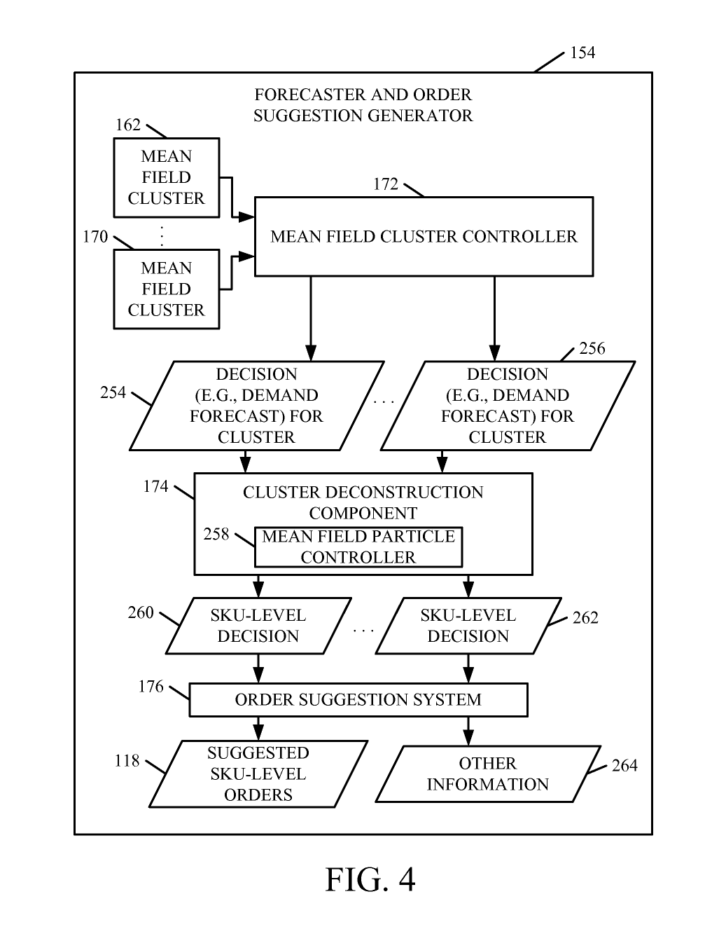

Cluster deconstruction component 174 then deconstructs each Mean Field cluster to obtain product decisions for the individual SKUs in the Mean Field cluster. This is indicated by block 232 in FIG. 3. In one example, cluster deconstruction component 174 employs pareto matching between the sensor or tracker representing the cluster and the individual members (or particles, e.g., the individual SKUs) in the cluster. This is indicated by block 234, and this is described in greater detail below with respect to FIGS. 4-6. In one example, the deconstruction transfers the decision made for a single Mean Field cluster into decisions made for the individual SKUs, in order to generate predicted state values (such as demand, inventory, profit, etc.). This is indicated by block 236. It can also generate the corresponding uncertainties 238. This information can be provided to order suggestion system 176 which generates suggested SKU-level orders 240. The deconstruction can include other items as well, and this is indicated by block 242.

Forecaster and order suggestion generator 154 outputs the product decisions for individual SKUs, and it can output corresponding information at the cluster or group level as well, for use by other systems. This is indicated by block 244 in FIG. 3. For instance, the information can be provided to ordering and inventory management systems, as indicated by block 246. It can be provided to assortment planning systems as indicated by block 248, or to other systems, as indicated by block 250.

The information is also used to update the historical data 132 in business system 102. This is indicated by block 252.

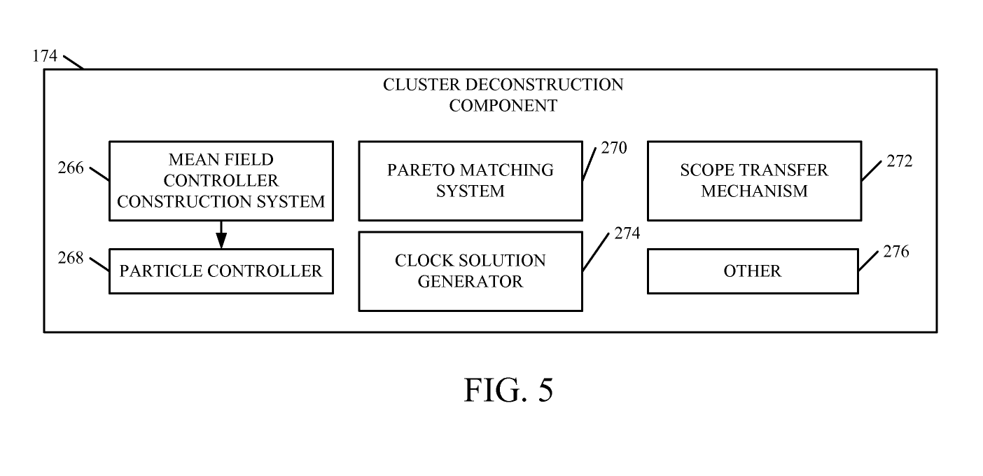

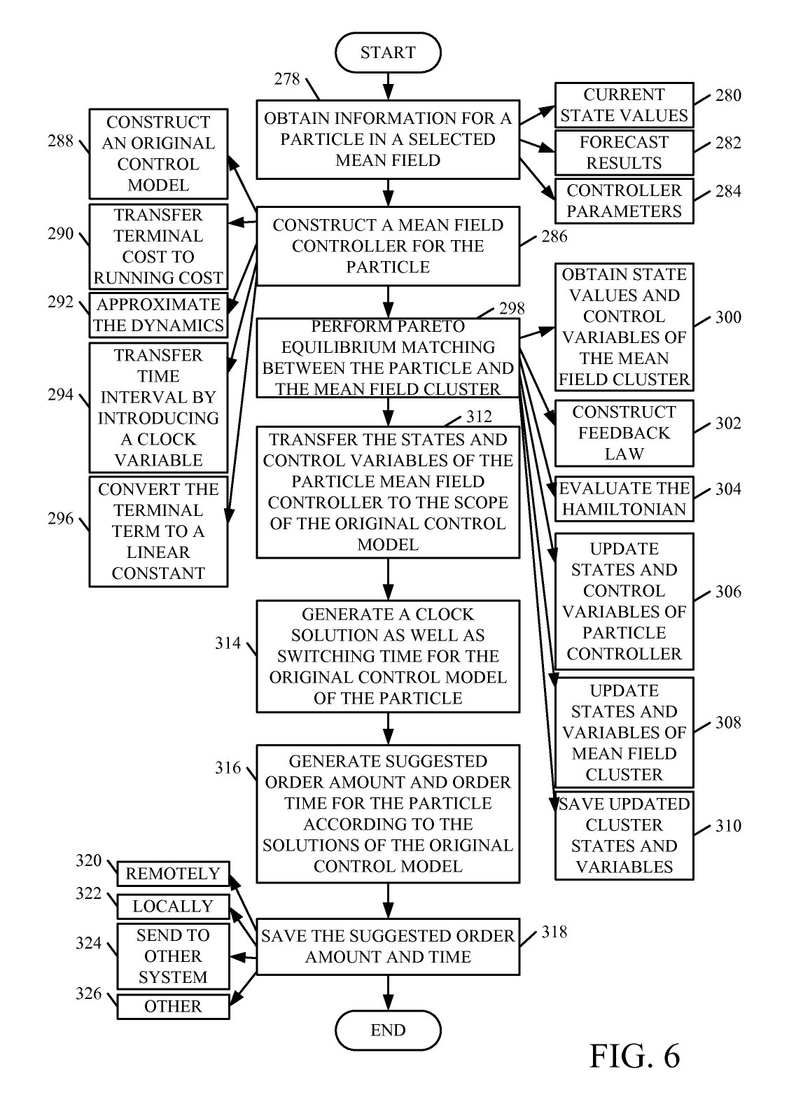

FIG. 4 shows the processing flow in forecaster and order suggestion generator 154 in more detail. FIG. 5 is a block diagram illustrating one example of cluster deconstruction component 174 in more detail. FIG. 6 is a flow diagram illustrating one example of the operation of cluster deconstruction component 174. FIGS. 4-6 will now be described in conjunction with one another.

It should also be noted that, with respect to FIG. 4, the computations can be distributed, such as in a cloud computing environment, or in another remote server environment. FIG. 4 shows that Mean Field cluster controller 172 first receives the Mean Field clusters 162-170. It generates decisions (e.g., demand forecasts) for each cluster. The decision for Mean Field cluster 162 is represented by block 254 in FIG. 4. The decision for cluster 170 is represented by block 256. The Mean Field cluster-level decisions are provided to cluster deconstruction component 174. It should be noted that, where the processing is distributed, a separate cluster deconstruction component 174 can be provided to process the decisions for each individual Mean Field cluster 162-170. Therefore, while cluster deconstruction component 174 is shown as a single component processing all of the decisions 154-156 for the different Mean Field clusters, it could be divided and distributed processing can be employed as well.

In any case, in one example, component 174 generates a Mean Field particle controller 258 that operates on a given decision (such as decision 254) for a Mean Field cluster and deconstructs that decision to obtain SKU-level decisions 260-262, for the individual SKUs in the cluster corresponding to decision 254 (i.e., for the individual SKUs in Mean Field cluster 162). The SKU-cluster interaction can be controlled based on a set of rules as well. Again, order suggestion system 176 can be distributed to generate suggested orders from each of the individual SKU-level decisions 260-262, and it is shown as a single system for the sake of example only. It illustratively outputs the suggested SKU-level orders 118, along with any other information 264.

FIG. 5 shows that, in one example, cluster deconstruction component 174 includes a Mean Field controller construction system 256 that generates particle controllers 268 to process the information for the individual particles in a Mean Field cluster. Component 174 also illustratively includes a pareto matching system 270 that generates states and control variable values for the individual particles in the Mean Field cluster. It can include scope transfer mechanism 272 that transfers the states and control variables of the particle Mean Field controller 268 to a scope of an original control model, and clock solution generator 274 that generates a clock solution, and switching times, for the original control model of the particle. It can include other items 276 as well.

FIG. 6 shows that cluster deconstruction component 174 first obtains information for a particle in a selected Mean Field. This is indicated by block 278. The information can include current state values 280, forecast results 282, and controller parameters 284. The forecast results 282 illustratively include predicted demand, inventory, etc. which were decomposed from the forecast results of the group that contained the particle. The controller parameters 284 can be generated using off-line training mechanisms, or in other ways.

Mean Field controller construction system 266 then constructs a Mean Field controller for the particle. This is indicated by block 286. In doing this, system 266 can construct an original control model for the particle, as indicated by block 288. It can then transfer the terminal cost in the criterion to a running cost as indicated by block 290. It can then approximate the dynamics of the Mean Field particle, as indicated by block 292. It can also transform the time interval to a fixed time interval (such as between 0 and 1) by introducing a clock variable, as indicated by block 294, and it can then convert the terminal term to a linear constant as indicated by block 296.

Once the particle Mean Field controller 268 is constructed, pareto matching system 270 illustratively performs pareto equilibrium matching between the particle and the Mean Field cluster. This is indicated by block 298. In doing so, it first illustratively obtains state values and control variables for the Mean Field cluster. This is indicated by block 300. It then constructs a feedback law for the particle Mean Field controller 268 (with the controls of the Mean Field cluster as an extra input). This is indicated by block 302. It then evaluates a Hamiltonian with respect to the feedback law, as indicated by block 304. It then updates the states and control variables of the particle Mean Field controller 268. This is indicated by block 306. It then updates the states and the control variables of the Mean Field cluster (with the control variables of the particle Mean Field controller as an extra input). This is indicated by block 308. Finally, it saves the updated cluster states and variables as indicated by block 310. They can be saved locally, or to a cloud or other remote server environment, etc.

Scope transfer mechanism 272 then transfers the states and control variables of the particle Mean Field controller 268 to the scope of the original control model generated for the particle at block 288. Transferring the states and control variables is indicated by block 312 in FIG. 6.

Clock solution generator 274 then generates a clock solution as well as switching time for the original control model of the particle (again as constructed at block 288). This is indicated by block 314. The order suggestion system 176 then generates a suggested order amount and order time for the particle according to the solutions of the original control model. This is indicated by block 316. The suggested order amount and time are then saved. This is indicated by block 318. For instance, they can be saved to a cloud or remote server environment as indicated by block 320. They can also, or in the alternative, be saved locally, as indicated by block 322. They can be sent to other systems, such as business system 102. This is indicated by block 324. They can be saved or sent other places as well, and this is indicated by block 326.

It can thus be seen that the Mean Field-based forecast system can be used to accommodate large sale forecasting and optimization. It operates in polynomic time and allows distributed computation. This improves the operation of the forecasting system, itself. Because it operates in polynomic time and can be processed in distributed computing environments, it makes the calculation of the forecast and optimizations much more efficient. This greatly enhances the speed of the system and drastically reduces computational and memory overhead. It also preserves critical information at the individual SKU level, but uses aggregate Mean Field information to allow the business system 102 to generate overall trends and insight into the operations of the organization that employs business system 102. It can be used in assortment planning, inventory management and price optimization, among other places. The scalability to large data sets improves the operation of the business system as well, because it can obtain more accurate forecasting, assortment planning, inventory management, etc., and it can obtain this accurate information much more quickly.

A more formal description of forecast system 112 will now be provided.

It is first worth noting that the Mean Field model is applicable to systems with real-time or near real-time data, with sizes ranging from small data sets to very large data sets. The Mean Field model provides a practical and scalable method. It avoids the computation of correlation functions by associating individual particles with a Mean Field particle.

Instead of finding the interactions between all particles, the interaction of each particle is with respect to the Mean Field Particle. The entropy after interaction is maximized (that is, no further information can be extracted), which is also referred to above as Pareto equilibrium. The interaction between any two particles is determined through each one's interaction with the Mean Field. Mean Field depends on time (it reflects dynamic property of the original system), and the Mean Field Particle is propagated through time. Any time a single particle changes, it makes a change to the Mean Field Particle. The methodology involves many integrations that are performed numerically. They can be performed, for example, with the Runge-Kutta 3rd order method, and the modified Rosenbrock method.

The Mean Field model is applicable to many types of systems. Table 1 below shows examples of state variables for several example systems, including inventory management, and assortment planning

TABLE 1

| | | Mean Field states that |
|---|---|---|
| | States | connect each |
| States for inventory | for assortment | single SKU to |
| management example | planning example | other SKUs through |
| (per SKU) | (per SKU) | the Mean Field |
| Demand | Demand | Field capital (K) |
| Profit | Revenue, | Field capacity |
| | opportunity cost | |
| Inventory | Inventory | Field demand |
| Spoilage | Capacity (volume/ | Field opportunity cost |
| | mass) | |
| Order | Capital (K) | Field/Target profit |
| These states include the | Order | (associated with |
| expected value and standard | | revenue) |
| deviation. The uncertainties | | |
| of the states are captured in | | |
| a probability space. | | |

Markov processes can be generated using a set based function as the fundamental Kernel (or called the fundamental propagator) of the Markov chain, that is, μ(x(t)⊂Xₜ⊂ [symbol] ^{d}|x(tₘ),tₘ) and Xₜ is a Borel set, so x(t) is a set (instead of a singleton x(t)ε [symbol] ^{d}). The fundamental propagator uses one time memory, P_{1|1}(x,t|xₘ,tₘ). The systems under control (for example, assortment planning processes) are not stationary Markov Chains, and are not homogeneous, so the approach conditions on xₘ, tₘ and the states are modeled with probabilities. There are single particle states (for example, single SKUs), and a Mean Field particle state, which are propagated. The approach can apply the Pareto equilibrium to connect the two propagators. For example, the Pareto equilibrium between an SKU propagator and the Field propagator replaces the need to compute the correlation between SKUs.

As an example, the Mean Field Markov model for an assortment planning system, with an uncertainty propagation can include: actions per SKU (random variables):

Quality (function of demand and inventory),

Time (time to the next order);

Chapman Kolmogorov Propagator;

one time memory as a fundamental propagator P_{1|1}(x,t|x′,t′)=T(x,t|x′,t′), that is, the probability at time t will have x quantity given at time t′ it has x′. The approach discovers T(x,t|x′,t′) which provides enough information to construct Pₘ(xₘ,tₘ|x₁,t₁, . . . , xₘ₋₁,tₘ₋₁); and the algorithm for propagation uses a differential form,

$$\frac{\partial T ( x , t \vert {x}^{′} , {t}^{′} )}{\partial t} = 𝒜 ( t ) T ( x , t \vert {x}^{′} , {t}^{′} ) .$$

Each problem needs to determine the operator [symbol] (t). To propagate any function ρ(x), the operator [symbol] (t) satisfies,

$$𝒜 ( t ) ρ ( x ) = {lim}_{Δ t \to 0} \frac{1}{Δ t} \int d {x}^{′} ( T ( x , t + Δ t \vert {x}^{′} , {t}^{′} ) - T ( x , t \vert {x}^{′} , {t}^{′} ) ) ρ ( {x}^{′} ) \qquad Eq . 1$$

It is much easier to build [symbol] (t) than to find T(x,t|x′,t′).
The construction of [symbol] (t) is related to rules. It is assumed there is enough data to build [symbol] (t). For example, the probability propagator of a deterministic process is

\dot{x}=g(x(t))

x(t)εRⁿ

x(t₀)=x₀ Eq. 2

Assume g(x(t)) satisfies the Lipschitz condition, that is, ∥g(y)−g(x)∥≦K∥y−x∥. Let φₜ(x₀) be the solution of the differential equation. It must satisfy the following conditions:

$${ϕ}_{t + {t}^{′}} ( x ) = {ϕ}_{t} ( {ϕ}_{{t}^{′}} ( x ) ) \\ {ϕ}_{{t}_{0}} ( {x}_{0} ) = {x}_{0} \\ \frac{d {ϕ}_{t}}{d t} = {\dot{ϕ}}_{t} = g ( {ϕ}_{t} ) \qquad Eq . 3$$

Note that if g(x(t)) is a linear equation, φₜ⁻¹ always exists. But it is not true in the present case. Therefore a repair function does not exist. For a general deterministic process as above, the operator

$$𝒜 = - \frac{\partial }{\partial x} g ( x ) .$$

Therefore the associated differential Chapman Kolmogorov equation is

$$\frac{\partial T ( x , t \vert {x}^{′} , {t}^{′} )}{\partial t} = - \frac{\partial }{\partial x} g ( x ) T ( x , t \vert {x}^{′} , {t}^{′} )$$

Generating a distribution from the rules allows propagation to any time in the future.

As another example, for a jump process propagator (predictable jumps), consider predictable jumps (such as demand jumps triggered by rules and events). Let W(x|x′,t)Δt be the probability density function for a jump from x′ to x at some time in the time interval [t,t+Δt](note at the beginning of the time interval it is x′). Define Γ(x′,t)=∫dxW(x|x′,t) (that is, integration over all possible jumps).

A differential equation with jumps requires:

$$\frac{\partial }{\partial t} T ( x , t \vert {x}^{′} , {t}^{′} ) = \int d {x}^{″} [ W ( x \vert {x}^{″} , t ) T ( {x}^{″} , t \vert {x}^{′} , {t}^{′} ) - W ( {x}^{″} \vert x , t ) T ( x , t \vert {x}^{′} , {t}^{′} ) ] \qquad Eq . 5$$

(Inside the integration, the first part is the probability with a jump, the second part is the probability without a jump).

To construct a Mean Field pareto problem for the example of assortment planning, the Mean Field approach will include a forecaster and tracker. The Mean Field approach incorporates interactions between SKUs in a practical and scalable manner, using parallelization and distributed computing.

The Mean Field aggregation has a taxonomy to classify SKUs that are similar in a specific sense. To make an analogy, in real-time trading, investments are grouped by sector, such as energy sector, technology sector, etc., and when one sector increases, most of the investments in that sector also increase. The Mean Field approach applied to assortment planning also uses a classification system to group SKUs.

The SKUs can be classified, for example, according to: 1. Point-of-sale (POS) velocity, that is, rate of change in sales; 2. volume in the store, that is related to capacity; or 3. opportunity cost, among others. An optimization problem combined with statistical analyses is used to discover a useful classification, and to generate rules for classifying SKUs. Sensors (observable metrics) are created to update the classification scheme to achieve good performance.

A Mean Field forecaster and Mean Field tracker work in continuous time instead of discrete time, because the Mean Field changes so quickly, it would be necessary to discretize at very small increments. When jumps occur (for example, orders occur at discrete epochs), the Mean Field approach captures the effect of discrete changes, but the computation is efficient because the probability propagates continuously in time.

The mapping between Mean Field and individual SKU and the mapping between two Mean Fields (of different classifications) is done by constructing Pareto optimality and determining a Pareto equilibrium. The mapping provides a methodology to transfer Mean Field visual orders into individual SKU orders.

The criterion for the Mean Field is expressed as J(v,p(x,t)), where v is the order rate, and p(x,t) is the probability density.

In the Mean Field approach, the mean of the Mean Field, z(t), is determined by integrating over the probability density, which is a control variable in the optimization problem, and is time-varying. In a standard stochastic process, the process itself changes with time, and the probability density is adapted for each time instance. The Mean Field, in general, and for assortment planning in particular, is not a stationary (ergodic) process. In an ergodic process, the sampled mean and the cluster mean are the same, but this is not the case in assortment planning.

An example of the Mean Field LQ tracking criterion is given by:

$$\begin{matrix}J ( v , p ) = {\int }_{0}^{T} \frac{1}{2} {( x ( t ) - z ( t ) )}^{T} Q ( x ( t ) - z ( t ) ) + \frac{1}{2} {v}^{T} ( t ) Rv ( t ) d t + \frac{1}{2} {x}^{T} ( T ) Fx ( T ) + {x}^{T} ( T ) H & Eq . 6 \\ with z ( t ) = {\int }_{cluster space , K} Ϛ p ( Ϛ , t ) d Ϛ where K ⋐ {ℜ}^{n} & Eq . 7\end{matrix}$$

In the Mean Field tracking formulation, the Mean Field target is the expected value over the probability density (which is unknown, and found in the optimization).

The Mean Field tracker is an optimization problem over the space of controls (for example, orders), v, and the probability density, p(x,t), with the criterion

J(v,p)=∫₀^{T}½(x(t)−∫₀^{t}ζp(ζ,t)dζ)^{T}Q(x(t)−∫₀^{t}ζp(ζ,t)dζ)+½v^{T}(t)Rv(t)dt+½x^{T}(T)Fx(T)+x^{T}(T)H Eq. 8

and with constraints

\dot{x}(t)=A(u)x(t)+Bv(t)+f(t)

\dot{p}(x,t)= [symbol] (x,t)p(x,t₀) Eq. 9

and where the operator [symbol] is defined by

[symbol]

(x,t)ρ(x)=∫dx′└W(x|x′,t)ρ(x′)−W(x′|x,t)ρ(x) Eq. 10

and W(x|x′,t)Δt is the probability density function for a jump from x′ to x at some time in time interval [t,t+Δt] (note at the beginning of the time interval it is x′). The probability density function W is calculated for the Mean Field, and the Mean Field probability density gets propagated to determine the optimal control.

$$If z ( t ) = {\int }_{κ} Ϛ p ( Ϛ , t ) d Ϛ is known , \\ then the optimal solution is expressed as , \\ v * ( t ) = G ( t ) x ( t ) + Ψ ( t , z ( t ) ) \qquad Eq . 11$$

where G(t) is called the gain. Since z(t) is unknown, due to the unknown probability density p, and then knowing the probability density, a sequential optimization approach is used.

Assume z(t) is known, and use the propagation equation to solve for the unknown probability density p(x,t), and then knowing the probability density, solve for z(t).

In short, the Mean Field probability density gets propagated and an optimal control is determined for the Mean Field. The optimality is in the Pareto sense, balancing objectives for example, profit, capital (K), capacity (C), and other objectives determined from the soft rules. The probability W(x|x′,t), for example, for each SKU, is determined by playing a Pareto game with the Mean Field. This is a static game, and so the computation is manageable. The constraints for the game for an individual SKU can be based on empirical point-of-sale data and user rules. This approach makes the assortment planning problem scalable.

A summary of using the Mean Field approach for an assortment planning application will now be described. The controller operates on the Mean Field (that is, a group of SKUs). The methodology and algorithms to group SKUs into different Mean Fields is discussed above. The correlation between Mean Fields should illustratively not be orthogonal, that is, interactions between Mean Fields are illustratively necessary. An analogy of grouping SKUs to securitization, is to apply a similar idea used in credit card markets to handle debts. For example, SKUs may be classified as fast demand, medium demand and slow demand; and then a Mean Field is created with a certain percentage of SKUs belonging to fast demand classification, and a certain percentage belonging to medium demand classification, and so on. The average probability of the “security measure” of this Mean Field is illustratively the same as the other Mean Fields.

An example of grouping and approximation to Fokker-Planck equations for probability propagation will now be described.

An example programmable classifier or group forming component 150 can have the following variables:
State/SKU (which can include Demand, Uncertainty Demand, Inventory, Uncertainty Inventory, Profit, Uncertainty Profit, Order), and Time horizon.

All SKUs can be classified into several classes according to rules 156, 158 of classification. The rules can be designed to be functions of state values, time horizon, etc. As briefly discussed above with respect to FIG. 2, an example of rules is to classify SKUs according to the range of average demand. There can illustratively be some overlap along the edge between two adjacent classes. For example, classify SKUs with average demand between 10 and 100 as one class, and SKUs with average demand between 90 and 200 as another class so that the two classes have overlap.

Mean Field clustering component 152 mixes the elements chosen from each class to form several Blocks. These Blocks can be measured as “similar” under a certain measurement, for example the weighted demand of each block is similar. Each Block is a Mean Field, which has its own Mean Field dynamics. The former forecaster, controller, etc. described above can be designed for single SKU, and it can be applied directly to each Mean Field.

In order to get the dynamics of each Mean Field, define the sensor (or tracker) for each specific Mean Field. A sensor can be a “leading” SKU in the Block that capture the performance of the Mean Field, or a weighted mean of state of all SKUs, and so on.

To group SKUs from different classes into a single Block, the magnitude of the state and the time horizon of the grouped SKUs are normalized.

An example of cluster deconstruction component 174 receives a decision made for a single Block, and transfers it into decisions for individual SKUs grouped in that Block, to obtain deconstruction of a Block.

An example of modifications of the Mean Field controller for deconstruction is now discussed.

The states of the controller for the assortment planning application include demand, inventory, profit, order, and their respective uncertainties. They are denoted by a state vector y(t) and the dynamics of the controller are written as:

\dot{y}(t)=Φ(y(t),v(t)) Eq. 12

and the criterion of the controller is:

min∫₀^{T}(½(y(t)−\hat{y}(t))^{T}Q(y(t)−\hat{y}(t))+v(t)²R)dt+½(y(T)−\hat{y}(T))^{T}F(y(T)−\hat{y}(T))+(y(T)−\hat{y}(T))^{T}H(1) Eq. 13

where ŷ(t) is the given tracking value.

First, the terminal cost in the criterion is transferred to the running cost (as discussed above with respect to block 290 in FIG. 6) by introducing a new state variable w(t). Define

w(t)=½(y(t)−\hat{y}(T))^{T}F(y(t)−\hat{y}(T))+(y(t)−\hat{y}(T))^{T}H Eq. 14

and let the initial condition be a constant,

w(0)=½(y(0)−\hat{y}(T))^{T}F(y(0)−\hat{y}(T))+(y(0)−\hat{y}(T))^{T}H. Eq. 15

Then the terminal cost in Eq. 13 is replaced by w(T)=∫₀^{T}\dot{w}(t)dt−w(0), and the criterion in Eq. 13 is rewritten as

min∫₀^{T}(½(y(t)−\hat{y}(t))^{T}Q(y(t)−\hat{y}(t))+v(t)²R+\dot{w}(t))dt. Eq. 16

### Since

\dot{w}(t)=((y(t)−\hat{y}(T))^{T}F+H)\dot{y}(t)=((y(t)−\hat{y}(T))^{T}F+H)Φ(y(t),v(t)), Eq. 17

the criterion in Eq. 14 is further rewritten as

min∫₀^{T}(½(y(t)−\hat{y}(t))^{T}Q(y(t)−\hat{y}(t))+v(t)²R+((y(t)−\hat{y}(T))^{T}F+H)Φ(y(t),v(t))dt Eq. 18

Next, consider a particular interval [tᵢ,tᵢ₊₁), and assume that y(tᵢ) and v(tᵢ), are known. Then use them to find the solution with perturbation equations for y(t) and v(t),

y(t)=y(tᵢ)+δy(t),v(t)=v(tᵢ)+δv(t) Eq. 19

The dynamics are approximated (as in a block 292 of FIG. 6 above) and written as

$$δ \dot{y} ( t ) = Φ ( y ( {t}_{i} ) + δ y ( t ) , v ( {t}_{i} ) + δ v ( t ) ) \\ δ \dot{y} ( t ) \approx \frac{\partial Φ}{\partial y} {\vert}_{y ( {t}_{i} ) , v ( {t}_{i} )} δ y ( t ) + \frac{\partial Φ}{\partial v} {\vert}_{y ( {t}_{i} ) , v ( {t}_{i} )} δ v ( t ) . \qquad Eq . 20$$

where the approximation is in the Dirac sense.
The criterion in this particular interval [tᵢ, tᵢ₊₁) is

min∫ₜ_{ᵢ}^{t}^{ᵢ₊₁}(½(y(tᵢ)+δy(t)−\hat{y}(t))^{T}Q(y(tᵢ)+δy(t)−\hat{y}(t))+(v(tᵢ)+δv(t))²R+((y(tᵢ)+δy(t)−\hat{y}(T))^{T}F+H)Φ(y(tᵢ)+δy(t),v(tᵢ)+δv(t)))dt Eq. 21

which is rewritten as

min∫ₜ_{ᵢ}^{t}^{ᵢ₊₁}(½(δy(t)−(\hat{y}(t)−y(tᵢ)))^{T}Q(δy(t)−(\hat{y}(t)−y(tᵢ)))+(v(tᵢ)+δv(t))²R+((δy(t)−(\hat{y}(t)−y(tᵢ)))^{T}F+H)Φ(y(tᵢ)+δy(t),v(tᵢ)+v(t)))dt. Eq. 22

The quadratic tracking criterion appears as a consequence of linearizing in the Dirac sense.

Next, transform (as indicated at block 294 in FIG. 6 above) the problem from the time interval tε[tᵢ,tᵢ₊₁] to a fixed time interval τε[0, 1] by introducing a clock variable

$${u}_{c} ( τ ) = \frac{d t}{d τ} = {t}_{i + 1} - {t}_{i} . Then \frac{d y}{d t} = Φ ( y ( t ) , v ( t ) ) and$$

$$\frac{d y}{d τ} = \frac{d y}{d t} \frac{d t}{d τ} = Φ ( y ( t ) , v ( t ) ) {u}_{c} ( τ ) .$$

Then a criterion with a quadratic-affine terminal term is converted to a linear constant terminal term (as indicated at block 296 in FIG. 6 above), by introducing a new state variable and adding a running cost term.

This can be done as follows:

Terminal Cost: ½(x(T)−Y(T))^{T}F(x(T)−Y(T))+(x(T)−Y(T))^{T}H Eq. 23

Define: w(t)=½(x(t)−Y(T))^{T}F(x(t)−Y(T))+(x(t)−Y(T))^{T}H Eq. 24

And then: \dot{w}(t)=((x(t)−Y(T))^{T}F+H)\dot{x}(t) Eq. 25

Since \dot{x}(t)=G(x(t), v(t)), (1) is rewritten as:

\dot{w}(t)=((x(t)−Y(T))^{T}F+H)G(x(t),v(t)) Eq. 26

and the terminal part of the criterion becomes simply:

w(T). Eq. 27

To generate the Mean Field controller with terminal time as a decision variable, an extra variable, called the clock, is added to the controller and the tracking problem is modified accordingly. Since the clock variable enters the modified tracking problem as a multiplier (the detail is shown below), the clock problem is solved separately from solving the modified LQ tracking problem.

The original tracking problem (in general form) is

$${min}_{v , {t}_{i + 1}} {\int }_{{t}_{i}}^{{t}_{i + 1}} \frac{1}{2} {( x ( t ) - y ( t ) )}^{T} Q ( x ( t ) - y ( t ) ) + \frac{1}{2} {v ( t )}^{T} Rv ( t ) d t + \frac{1}{2} {( x ( {t}_{i + 1} ) - y ( {t}_{i + 1} ) )}^{T} F ( x ( {t}_{i + 1} ) - y ( {t}_{i + 1} ) ) + {( x ( {t}_{i + 1} ) - y ( {t}_{i + 1} ) )}^{T} H \\ s . t . \frac{d x ( t )}{d t} = G ( x ( t ) , v ( t ) ) \qquad Eq . 28$$

with initial condition x(tᵢ), where x(t) is the state, y(t) is the tracking value of the state, v(t) is the control variable, tᵢ is the starting time, and tᵢ₊₁ is the terminal time.

The original tracking problem is modified to include the clock variable. The decision variables are both v(t) and tᵢ₊₁. The tracking values in y(t) are known before setting up the above problem and are kept constant in the time interval [tᵢ, tᵢ₊₁], therefore, y(t) is denoted as y(tᵢ⁻), where the “−” indicates that the tracking values are determined before setting up the tracking problem.

The original tracking problem is not a linear-quadratic tracking problem since the dynamic equation of x(t), that is, G(x(t), v(t)), is defined by rules and can be of any form. The equation is linearized by introducing incremental variables as follows. The modified problem is a linear-quadratic tracking problem according to Dirac, since it is an estimation of the original problem and the higher order terms are ignored.

$$Let δ x ( t ) = x ( t ) - x ( {t}_{i} ) , and δ v ( t ) = v ( t ) - v ( {t}_{i} ) . \\ Then δ \dot{x} ( t ) = \dot{x} ( t ) . Therefore \\ \begin{matrix}δ \dot{x} ( t ) = G ( δ x ( t ) + x ( {t}_{i} ) , δ v ( t ) + v ( {t}_{i} ) ) \\ \approx G ( x ( {t}_{i} ) , v ( {t}_{i} ) ) + \frac{\partial G}{\partial x} {{\vert}_{( x ( {t}_{i} ) , v ( {t}_{i} ) )} \cdot δ x ( t ) + \frac{\partial G}{\partial v} \vert}_{( x ( {t}_{i} ) , v ( {t}_{i} ) )} \cdot δ v ( t )\end{matrix} \qquad Eq . 29$$

And let δy(tᵢ⁻)=y(tᵢ⁻)−x(tᵢ). Then use the following linear-quadratic tracking problem to estimate the original tracking problem

$${min}_{δ v , {t}_{i + 1}} {\int }_{{t}_{i}}^{{t}_{i + 1}} \frac{1}{2} {( δ x ( t ) - δ y ( {t}_{i}^{-} ) )}^{T} Q ( δ x ( t ) - δ y ( {t}_{i}^{-} ) ) + \frac{1}{2} δ {v ( t )}^{T} R δ v ( t ) d t + \frac{1}{2} {( δ x ( {t}_{i + 1} ) - δ y ( {t}_{i}^{-} ) )}^{T} F ( δ x ( {t}_{i + 1} ) - y ( {t}_{i}^{-} ) ) + {( δ x ( {t}_{i + 1} ) - δ y ( {t}_{i}^{-} ) )}^{T} H \\ s . t . \frac{d δ x ( t )}{d t} = A \cdot δ x ( t ) + B \cdot δ v ( t ) + f \qquad Eq . 30$$

with initial condition δx(tᵢ)=0,
where

$$A = \frac{\partial G}{\partial x} {\vert}_{( x ( {t}_{i} ) , v ( {t}_{i} ) )} , \\ and B = \frac{\partial G}{\partial v} {\vert}_{( x ( {t}_{i} ) , v ( {t}_{i} ) )} , \\ and f = G ( x ( {t}_{i} ) , v ( {t}_{i} ) ) ,$$

by Dirac method.

Simplify the terminal term from the criterion of the tracking problem by adding an extra variable w(t)

$$w ( t ) = \frac{1}{2} {( δ x ( t ) - δ y ( {t}_{i}^{-} ) )}^{T} F ( δ x ( t ) - y ( {t}_{i}^{-} ) ) + {( δ x ( t ) - δ y ( {t}_{i}^{-} ) )}^{T} H \\ then \\ \begin{matrix} \frac{d w ( t )}{d t} = ( {( δ x ( t ) - δ y ( {t}_{i}^{-} ) )}^{T} \cdot F + {H}^{T} ) \cdot δ \dot{x} ( t ) \\ = ( {( δ x ( t ) - δ y ( {t}_{i}^{-} ) )}^{T} \cdot F + {H}^{T} ) \cdot ( A \cdot δ x ( t ) + B \cdot δ v ( t ) + f )\end{matrix} \qquad Eq . 32$$

with initial condition

w(tᵢ)=½(δx(tᵢ)−δy(tᵢ⁻))^{T}F(δx(tᵢ)−y(tᵢ⁻))+(δx(tᵢ)−δy(tᵢ⁻))^{T}H. Eq. 33

The tracking value of the new variable w(t) is 0. Let

$$\tilde{x} ( t ) = [ \begin{matrix}δ x ( t ) \\ w ( t )\end{matrix} ] , let \tilde{y} ( {t}_{i}^{-} ) = [ \begin{matrix}δ y ( {t}_{i}^{-} ) \\ 0\end{matrix} ] ,$$

let \tilde{v}(t)=δv(t) and let

$$\tilde{Q} = [ \begin{matrix}Q & 0 \\ 0 & 0\end{matrix} ] .$$

Now, the linear quadratic tracking problem is written as,

$${min}_{δ v , {t}_{i + 1}} {\int }_{{t}_{i}}^{{t}_{i + 1}} \frac{1}{2} {( \tilde{x} ( t ) - \tilde{y} ( {t}_{i}^{-} ) )}^{T} \tilde{Q} ( \tilde{x} ( t ) - \tilde{y} ( {t}_{i}^{-} ) ) + \frac{1}{2} {\tilde{v} ( t )}^{T} R \tilde{v} ( t ) d t + w ( {t}_{i + 1} ) \\ s . t . \frac{d \tilde{x} ( t )}{d t} = \tilde{G} ( \tilde{x} ( t ) , \tilde{v} ( t ) ) \qquad Eq . 34$$

with initial condition

$$\tilde{x} ( {t}_{i} ) = [ \begin{matrix}δ x ( {t}_{i} ) \\ w ( {t}_{i} )\end{matrix} ] ,$$

where δx(tᵢ)=0 and w(tᵢ) is given above.
Also, w(tᵢ₊₁) is written as

$$[ \begin{matrix}0 & 1\end{matrix} ] \cdot [ \begin{matrix}δ x ( t ) \\ w ( t )\end{matrix} ] = {\tilde{H}}^{T} \cdot \tilde{x} ( {t}_{i + 1} ) .$$

The time interval [tᵢ, tᵢ₊₁] is mapped to a unit interval [0, 1] by introducing the clock variable and defining a clock dynamic equation as follows,

$$\frac{d t ( τ )}{d τ} = {u}_{c} ( τ ) \qquad Eq . 35$$

with t(0)=tᵢ, t(1)=tᵢ₊₁. Let

$${x}^{\approx } ( τ ) = [ \begin{matrix}\tilde{x} ( ( τ ) ) \\ t ( τ )\end{matrix} ] ,$$

and let \tilde{\tilde{v}}(τ)=\tilde{v}(t(τ)).
Converting to a new time τ yields,

$$\begin{matrix}\frac{d \tilde{x} ( t )}{d t} = \frac{d \tilde{x} ( t ( τ ) )}{d τ} \cdot \frac{d τ}{d t} = \frac{d \tilde{x} ( t ( τ ) )}{d τ} \cdot \frac{1}{{u}_{c} ( τ )} \\ that is , & Eq . 36 \\ \frac{d \tilde{x} ( t ( τ ) )}{d τ} = {u}_{c} ( τ ) \cdot \frac{d \tilde{x} ( t )}{d t} = {u}_{c} ( τ ) \cdot \tilde{G} ( \tilde{x} ( t ( τ ) ) , {v}^{\approx } ( τ ) ) . & Eq . 37\end{matrix}$$

Therefore, the dynamics of \tilde{\tilde{x}}(τ) become

$$\begin{matrix}\frac{d {x}^{\approx } ( τ )}{d τ} = [ \begin{matrix}\frac{d {x}^{\approx } ( t ( τ ) )}{d τ} \\ \frac{d t}{d τ}\end{matrix} ] \\ = {u}_{c} ( τ ) \cdot [ \begin{matrix}\tilde{G} ( \tilde{x} ( t ( τ ) ) , \tilde{v} ( t ( τ ) ) ) \\ 1\end{matrix} ] \\ = {u}_{c} ( τ ) \cdot {G}^{\approx } ( {x}^{\approx } ( τ ) , {v}^{\approx } ( τ ) )\end{matrix} \qquad Eq . 38$$

The criterion is modified as follows. Let

$${y}^{\approx } ( {t}_{i}^{-} ) = ( \begin{matrix}\tilde{y} ( {t}_{i}^{-} ) \\ 1\end{matrix} ) ,$$

and let

$${Q}^{\approx } = [ \begin{matrix}\tilde{Q} & 0 \\ 0 & 0\end{matrix} ] .$$

Replace t by τ and replace dt by u_{c}(τ)·dτ in the criterion, to get

$${min}_{{v}^{\approx } ; {u}_{c} ( τ )} {\int }_{0}^{1} ( \frac{1}{2} {( {x}^{\approx } ( τ ) - {y}^{\approx } ( {t}_{i}^{-} ) )}^{T} {Q}^{\approx } ( {x}^{\approx } ( τ ) - {y}^{\approx } ( {t}_{i}^{-} ) ) + \frac{1}{2} {{v}^{\approx } ( τ )}^{T} R {v}^{\approx } ( τ ) ) \cdot {u}_{c} ( τ ) d τ + {w}^{\approx } ( 1 ) \\ s . t . \frac{d {x}^{\approx } ( τ )}{d τ} = {u}_{c} ( τ ) \cdot {G}^{\approx } ( {x}^{\approx } ( τ ) , {v}^{\approx } ( τ ) ) \qquad Eq . 39$$

with initial condition

$${x}^{\approx } ( 0 ) = [ \begin{matrix}δ x ( 0 ) \\ w ( 0 ) \\ t ( 0 )\end{matrix} ]$$

$$and$$

$${w}^{\approx } ( 1 ) = [ \begin{matrix}0 & 1 & 0\end{matrix} ] \cdot [ \begin{matrix}δ x ( 1 ) \\ w ( 1 ) \\ t ( 1 )\end{matrix} ] = {{{H}^{\approx }}^{T} \cdot {x}^{\approx } ( 1 ) .}^{ }$$

The clock u_{c}(τ) is solved separately from solving the above tracking problem, that is, the above problem is solved with only \tilde{\tilde{v}} as the decision variable,

$${min}_{{v}^{\approx }} {\int }_{0}^{1} ( \frac{1}{2} {( {x}^{\approx } ( τ ) - {y}^{\approx } ( {t}_{i}^{-} ) )}^{T} {Q}^{\approx } ( {x}^{\approx } ( τ ) - {y}^{\approx } ( {t}_{i}^{-} ) ) + \frac{1}{2} {{v}^{\approx } ( τ )}^{T} R {v}^{\approx } ( τ ) ) \cdot {u}_{c} ( τ ) d τ + {{H}^{\approx }}^{T} \cdot {x}^{\approx } ( 1 ) \\ s . t . \frac{d {x}^{\approx } ( τ )}{d τ} = {u}_{c} ( τ ) \cdot {G}^{\approx } ( {x}^{\approx } ( τ ) , {v}^{\approx } ( τ ) ) \qquad Eq . 40$$

with initial condition

$${x}^{\approx } ( 0 ) = [ \begin{matrix}δ x ( 0 ) \\ w ( 0 ) \\ t ( 0 )\end{matrix} ] .$$

This procedure converts the Mean Field approximation algorithm with a variable time horizon to a Mean Field control problem with a known finite horizon [0,1].

The controller provides a solution with an affine form, such as x(0)+δx(τ), so that it can easily be incorporated into a feedback control using a Mean Field algorithm. The approach starts with the original tracking problem, treats the terminal time as a decision variable, and transforms the problem into a fixed [0,1] time interval, and then linearizes around time 0.

To do this, start with the original tracking problem with nonlinear dynamics, and a quadratic criterion with a quadratic-affine terminal term.

The original tracking problem (in general form)

$${min}_{v , {t}_{i + 1}} {\int }_{{t}_{i}}^{{t}_{i + 1}} \frac{1}{2} {( x ( t ) - y ( t ) )}^{T} Q ( x ( t ) - y ( t ) ) + \frac{1}{2} {v ( t )}^{T} Rv ( t ) d t + \frac{1}{2} {( x ( {t}_{i + 1} ) - y ( {t}_{i + 1} ) )}^{T} F ( x ( {t}_{i + 1} ) - y ( {t}_{i + 1} ) ) + {( x ( {t}_{i + 1} ) - y ( {t}_{i + 1} ) )}^{T} H \\ s . t . \frac{d x ( t )}{d t} = G ( x ( t ) , v ( t ) ) \qquad Eq . 41$$

with initial condition x(tᵢ), where x(t) is the state, y(t) is the tracking value of the state, v(t) is the control variable, tᵢ is the (known) starting time, and tᵢ₊₁ is the (unknown) terminal time.

It should be noted that the decision variables are both v(t) and tᵢ₊₁. The tracking values in y(t) are known before setting up the above problem. The approach treats them as constant in the time interval [tᵢ, tᵢ₊₁], therefore y(t) is set to y(tᵢ⁻) in the interval, where the “−” indicates that the tracking values are determined before the tracking problem is set up.

The original tracking problem is typically not a linear-quadratic tracking problem since the dynamic equation of x(t), that is, G(x(t), v(t)), can be of any form defined by rules. The initial condition for v(t) is the last value of v in the previous interval, denoted v(tᵢ⁻).

This tracking problem is nonlinear. It computes an affine transformation relative to the initial value of the state at the beginning of the interval by introducing incremental variables as follows. The modified problem is a linear-quadratic tracking problem, which is an estimation of the original problem in the Dirac sense, since the higher order terms of the approximation are ignored.

Let δ\tilde{x}(τ)=\tilde{x}(τ)−\tilde{x}(0) and δ\tilde{v}(τ)=\tilde{v}(τ)−\tilde{v}(0). Also, let δ\tilde{w}(τ)=\tilde{w}(τ)−\tilde{w}(0). And, let δ\tilde{t}(τ)=t(τ)−t(0). Eq. 42

Taking the derivative yields, δ\tilde{\dot{x}}(τ)=\tilde{\dot{x}}(τ), and using a Dirac approximation, gives,

$$\begin{matrix}\begin{matrix} \frac{d δ \tilde{x} ( τ )}{d τ} = δ \dot{\tilde{x}} ( τ ) \\ = {u}_{c} ( τ ) \cdot G ( δ \tilde{x} ( τ ) + \tilde{x} ( 0 ) , δ \tilde{v} ( τ ) + \tilde{v} ( 0 ) ) \\ \approx {u}_{c} ( τ ) \cdot ( G ( \tilde{x} ( 0 ) , \tilde{v} ( 0 ) ) + \frac{\partial G}{\partial \tilde{x}} {\vert}_{( \tilde{x} ( 0 ) , \tilde{v} ( 0 ) )} \cdot \\ δ \tilde{x} ( τ ) + \frac{\partial G}{\partial \tilde{v}} {\vert}_{( \tilde{x} ( 0 ) , \tilde{v} ( 0 ) )} \cdot δ \tilde{v} ( τ ) )\end{matrix} \\ And , & Eq . 43 \\ \frac{d δ \tilde{w} ( τ )}{d τ} = {u}_{c} ( τ ) \cdot ( {( δ \tilde{x} ( τ ) + \tilde{x} ( 0 ) - \tilde{y} ( 0 ) )}^{T} \cdot F + {H}^{T} ) \cdot G ( δ \tilde{x} ( τ ) + \tilde{x} ( 0 ) , δ \tilde{v} ( τ ) + \tilde{v} ( 0 ) ) \approx {u}_{c} ( τ ) \cdot ( ( {( \tilde{x} ( 0 ) - \tilde{y} ( 0 ) )}^{T} \cdot F + {H}^{T} ) \cdot G ( \tilde{x} ( 0 ) , \tilde{v} ( 0 ) ) + F \cdot G ( \tilde{x} ( 0 ) , \tilde{v} ( 0 ) ) \cdot δ \tilde{x} ( τ ) + ( {( \tilde{x} ( 0 ) - \tilde{y} ( 0 ) )}^{T} \cdot F + {H}^{T} ) \cdot \frac{\partial G}{\partial \tilde{x}} {\vert}_{( \tilde{x} ( 0 ) , \tilde{v} ( 0 ) )} \cdot δ \tilde{x} ( τ ) + ( {( \tilde{x} ( 0 ) - \tilde{y} ( 0 ) )}^{T} \cdot F + {H}^{T} ) \cdot \frac{\partial G}{\partial \tilde{v}} {\vert}_{( \tilde{x} ( 0 ) , \tilde{v} ( 0 ) )} \cdot δ \tilde{v} ( τ ) ) & Eq . 44\end{matrix}$$

And, letting [symbol] (τ)=u_{c}(τ)−u_{c} (0), yields

$$\frac{d δ \tilde{t} ( τ )}{d τ} = {u}_{c} ( τ ) = δ ( τ ) + {u}_{c} ( 0 ) . \qquad Eq . 45$$

Write the three dynamic equations in vector/matrix format, letting

$${x}^{\approx } ( τ ) = [ \begin{matrix}δ \tilde{x} ( τ ) \\ δ \tilde{w} ( τ ) \\ δ \tilde{t} ( τ )\end{matrix} ] .$$

### Then

$$\begin{matrix}\frac{d {x}^{\approx } ( τ )}{d τ} = [ \begin{matrix}δ \dot{\tilde{x}} ( τ ) \\ δ \dot{\tilde{w}} ( τ ) \\ δ \dot{\tilde{t}} ( τ )\end{matrix} ] = \tilde{A} \cdot {x}^{\approx } ( τ ) + \tilde{B} \cdot δ \tilde{v} ( τ ) + \tilde{f} \\ where & Eq . 46 \\ \tilde{A} = [ \begin{matrix}\frac{\partial G}{\partial \tilde{x}} {\vert}_{( \tilde{x} ( 0 ) , \tilde{v} ( 0 ) )} & 0 & 0 \\ \begin{matrix}F \cdot G ( \tilde{x} ( 0 ) , \tilde{v} ( 0 ) ) + ( {( \tilde{x} ( 0 ) - \tilde{y} ( 0 ) )}^{T} \cdot \\ F + {H}^{T} ) \cdot \frac{\partial G}{\partial \tilde{x}} {\vert}_{( \tilde{x} ( 0 ) , \tilde{v} ( 0 ) )}\end{matrix} & 0 & 0 \\ 0 & 0 & 0\end{matrix} ] & Eq . 47 \\ \tilde{B} = [ \begin{matrix}{u}_{c} ( τ ) \cdot \frac{\partial G}{\partial \tilde{v}} {\vert}_{( \tilde{x} ( 0 ) , \tilde{v} ( 0 ) )} \\ {u}_{c} ( τ ) \cdot ( {( \tilde{x} ( 0 ) - \tilde{y} ( 0 ) )}^{T} \cdot F + {H}^{T} ) \cdot \frac{\partial G}{\partial \tilde{v}} {\vert}_{( \tilde{x} ( 0 ) , \tilde{v} ( 0 ) )} \\ 0\end{matrix} ] \\ and & Eq . 48 \\ \tilde{f} = [ \begin{matrix}{u}_{c} ( τ ) \cdot G ( \tilde{x} ( 0 ) , \tilde{v} ( 0 ) ) \\ {u}_{c} ( τ ) \cdot ( {( \tilde{x} ( 0 ) - \tilde{y} ( 0 ) )}^{T} \cdot F + {H}^{T} ) \cdot G ( \tilde{x} ( 0 ) , \tilde{v} ( 0 ) ) \\ {u}_{c} ( τ )\end{matrix} ] & Eq . 49\end{matrix}$$

The initial conditions are:

$${x}^{\approx } ( 0 ) = [ \begin{matrix}δ \tilde{x} ( 0 ) \\ δ \tilde{w} ( τ ) \\ δ \tilde{t} ( τ )\end{matrix} ] = [ \begin{matrix}0 \\ 0 \\ 0\end{matrix} ] \qquad Eq . 50$$

and \tilde{x}(0)=x(tᵢ), \tilde{w}(0)=0, t(0)=tᵢ, \tilde{y}(0)=y(tᵢ⁻), and \tilde{v}(0)=v(tᵢ⁻).
Also, include upper and lower bounds on the clock, as:

u_{c}_{ₘᵢₙ}≦u_{c}(τ)≦u_{c}_{ₘₐₓ}. Eq. 51

The idea is to keep u_{c}(τ) constant for the regulator problem, and treat u_{c}(τ) as a variable in the non-regulator problem. The optimality conditions allow us to separate the solutions for δ\tilde{v}(τ) and a bang-bang solution for u_{c}(τ) over a small time interval.

Now, the criterion of the problem is:

∫₀¹½((δ\tilde{x}(τ)−\hat{y}(1)^{T}Q(δ\tilde{x}(τ)−\tilde{y}(1))+(δ\tilde{v}(τ)−\tilde{v}(1)²R))dτ+δ\tilde{w} Eq. 52

and note that this problem tracks the future \tilde{y}(1), not the past. Also, the matrices Ã, \tilde{B}, \tilde{f} are evaluated at the beginning of the interval and are held constant throughout the interval. This is possible by using the bang-bang structure of the clock u_{c}(τ) and determining whether it is at u_{c}_{ₘᵢₙ} or u_{c}_{ₘₐₓ}. It changes only once in the interval.
The Hamiltonian of the system is written as:

$$\begin{matrix}H = L ( δ \tilde{x} , δ \tilde{w} , δ \tilde{v} ) + {p ( τ )}^{T} \frac{d δ \tilde{x} ( τ )}{d τ} + λ ( τ ) \frac{d δ \tilde{w} ( τ )}{d τ} + μ ( τ ) \frac{d δ \tilde{t} ( τ )}{d τ} \\ where & Eq . 53 \\ L ( δ \tilde{x} , δ \tilde{w} , δ \tilde{v} ) = \frac{1}{2} ( {( δ \tilde{x} ( τ ) - \tilde{y} ( 1 ) )}^{T} Q ( δ \tilde{x} ( τ ) - \tilde{y} ( 1 ) ) + ( δ \tilde{v} ( τ ) - {\tilde{v} ( 1 )}^{2} R ) ) . & Eq . 54\end{matrix}$$

Claim: The algorithm performs a “quasi-separation”, letting

$$\begin{matrix}{H}_{LQT} = L ( δ \tilde{x} , δ \tilde{w} , δ \tilde{v} ) + {p ( τ )}^{T} \frac{d δ \tilde{x} ( τ )}{d τ} + λ ( τ ) \frac{d δ \tilde{w} ( τ )}{d τ} \\ and & Eq . 55 \\ {H}_{clock} = μ ( τ ) \frac{d δ \tilde{t} ( τ )}{d τ} . & Eq . 56\end{matrix}$$

Then, solve for the co-states, p(τ), λ(τ), μ(τ), using the terminal conditions p(1)=0 and λ(1)=1. The clock solution is a bang-bang solution, given by,

if H*_{clock}<H_{clock} then u_{c}(τ)=u_{cmin}

if H*_{clock}>H_{clock} then u_{c}(τ)=u_{cmax} Eq. 57

and the switching time is when

H*_{clock}=H_{clock}. Eq. 58

An example of the procedure is to start with all of the SKUs and then use a classifier to assign SKUs to blocks based on rules. Assume the rules are provided by the user (such as, by demand levels, profit levels, uncertainty, etc.). The number of blocks are much smaller than the number of SKUs. Then Mean Field groups are created, using a few SKUs from the blocks. The characterization of the groups is used to define the Mean Field aggregators.

Each original SKU i is characterized by: time interval of activity tᵢ, tᵢ₊₁, G, nonlinear dynamics, parameters Qⁱ, Fⁱ, Rⁱ, Hⁱ, clock limits, u_{c}_{ₘᵢₙ} and u_{c}_{ₘₐₓ}.

The operation of interrogation system 400 will now be described. It may be that, after a user queries the forecaster and optimizer for a forecast, the user may see the forecast but then wonder why it is different from his or her expectations. In that case, interrogation system 400 can provide an interpretation to the user indicating which rules were active during the forecast or optimization and why. This can allow the user to make adjustments to improve performance.

Interrogation system 400 thus provides significant technical advantages. For instance, in a forecasting system where there are a great many different rules which can apply to a forecast, the process of identifying which of those rules are active, and why, would normally be extremely cumbersome and computationally expensive. For example, the present discussion advantageously avoids enumerating all rules in the system and then having the user request the system to perform a large computation to determine which rules applied to individual forecasts for SKUs. Because, as is described below, the interrogation system interacts with the forecasting system 112 and/or optimization system 113 that employ mean field clustering, the various states in the forecaster 112 and optimization system 113 are obtained and the active rules (and in one example their degree of effectiveness) can quickly be identified, interpreted, and output for user interaction. This significantly enhances the speed of the system and greatly reduces computational and memory overhead.

FIG. 7 shows a block diagram of one portion of interrogation system 400. In the example shown in FIG. 7, interrogation system 400 can include processor 402, user interface component 404, active rule detector 406, active rule buffer 408, rule collection component 410, rule trajectory buffer 412, and interpretation engine 414. It can include other items 416 as well. FIG. 7 also shows that, in one example, system 400 has access to a rule data store 418 that stores the various rules employed by forecasting system 112 and optimization system 113. FIG. 7 also shows that interrogation system 400 can receive state information 420 from forecast system 112 and optimization system 113. It can also illustratively receive other information from other sources and services 120.

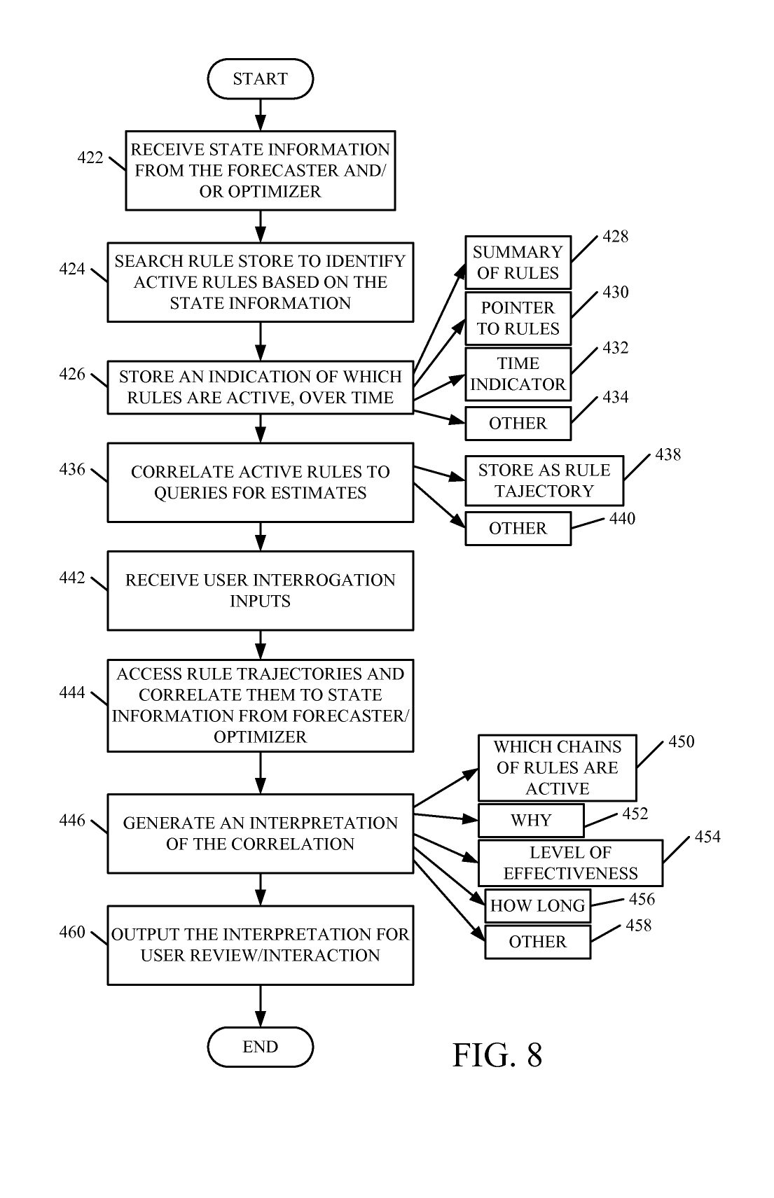

FIG. 8 is a flow diagram illustrating one example of the operation of interrogation system 400. System 400 first receives the state information from forecast system 112 and/or optimization system 113. This is indicated by block 422. Active rule detector 406 then searches the rule store 418 to identify active rules, based upon that state information. This is indicated by block 424. It stores some indication of the active rules, which were incrementally activated and deactivated, over time, in active rule buffer 408. This is indicated by block 426. It can store a summary of the identified rules as indicated by block 428. It can store a pointer back to data store 418, for the rules, as indicated by block 430. It can also store a time indicator (e.g., a timestamp) corresponding to when the various identified rules were activated and deactivated. This is indicated by block 432. It can store other items 434 as well.

Rule collection component 410 then correlates the active rules to the queries for estimates or optimizations that were submitted by the user. This is indicated by block 436. This correlation is stored in rule trajectory buffer 412. This is indicated by block 438. Additional information indicative of rule trajectories can be stored as well, and this is indicated by block 440.

At some point, interpretation engine 414 receives an inquiry or interrogation input from user 108. This is indicated by block 442. For instance, it may be that user 108 wishes to know why the particular suggested order, forecast, or optimization came out the way it did. In that case, interpretation engine 414 accesses the rule trajectories stored in buffer 412 and correlates them to the state information received from the forecast system 112 and optimization system 113. This is indicated by block 444. It then generates an interpretation of that correlation as indicated by block 446. The interpretation is indicated by block 448 in FIG. 7.

For instance, in one example, interpretation 448 can be a user interface display, or another type of mechanism which surfaces information for user 108, which indicates which chains of rules were active in forecast system 112 and/or optimization system 113, at which times. This is indicated by block 450. It can also provide an indication as to why those rules were activated. This is indicated by block 452. It can provide an indication that identifies the level of effectiveness of each rule, when the particular forecast or optimization was made. This is indicated by block 454. It can indicate when and how long the particular rules in the various chains of rules were activated. This is indicated by block 456. It can provide an output indicating the state of the forecast system 112 or optimization system 113 in other ways as well, and this is indicated by block 458.

The interpretation 448 thus surfaces information indicating the state of the forecast system 112 and optimization system 113, over time, and correlates it to various requests of user 108. This allows the user 108 to quickly determine the basis by which forecast system 112 or optimization system 113 generated the forecast or optimization. This is output for user review and interaction. This is indicated by block 460. By way of example, it may be that interpretation 448 includes a plurality of user input mechanisms that allow user 108 to actuate them and drill down into more detailed information regarding the particular chains of rules and rule sequences that were activated, when they were activated, why, what level of effectiveness they were given, etc. These types of user interactions are indicated for the sake of example only.

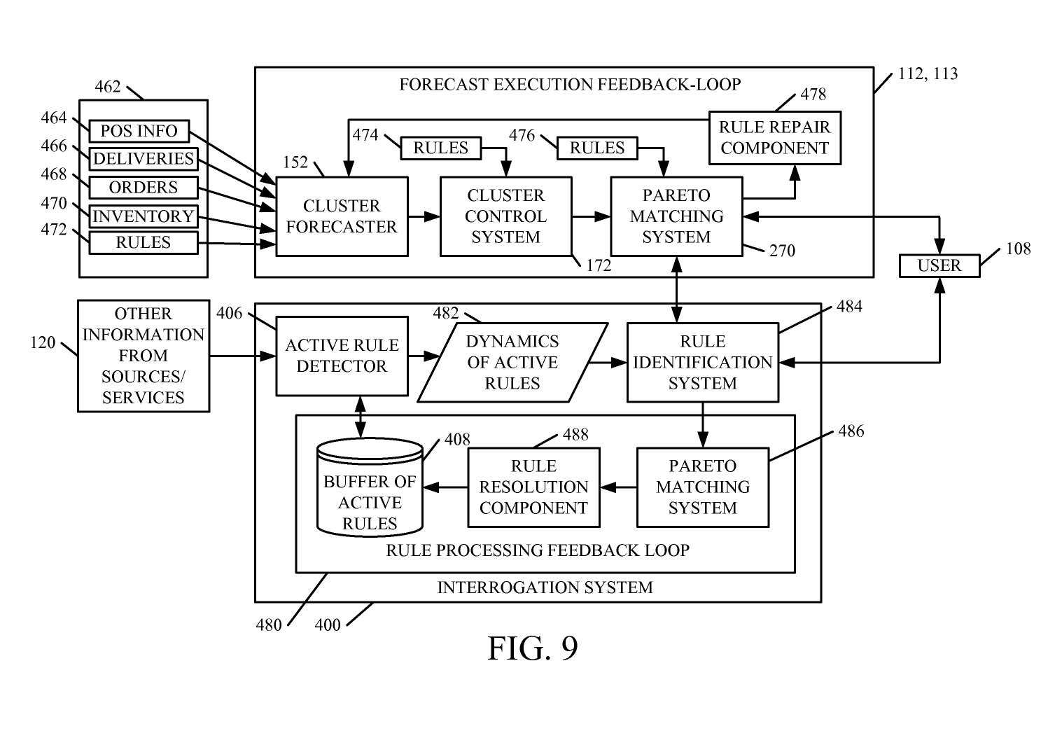

FIG. 9 is a block diagram showing different portions of forecast system 112 (or optimization system 113) and interrogation system 400. FIG. 9 shows that, in one example, systems 112 and/or 113 can include cluster forecaster 152, cluster control system 172 and pareto matching system 270. FIG. 9 also shows that systems 112/113 receive a set of information 462 from computing system 102. For instance, that information can include point of sale information 464, delivery information 466 that is indicative of deliveries, order information 468 that is indicative of orders, inventory information 470 that identifies various items of inventory and inventory levels, rules 472 that can include user defined rules and other rules that are used to group SKUs and generate mean field clusters. Cluster forecaster 152 forecasts the clusters and control system 172 controls the clusters. System 270 extracts forecasts and orders for individual SKUs, as described above. FIG. 9 also shows that cluster control system 172 can receive or access its own set of rules 474, and pareto matching system 270 can also access or receive a set of rules 476. Rule repair component 478, as is described below, can be used to modify the rules or various thresholds to ensure that the mean field clusters conform to the rules used to generate them. The items described with respect to systems 112 and 113 form a forecast execution feedback loop which is described below.

FIG. 9 also shows that interrogation system 400 can be configured to include rule processing feedback loop 480. The rule processing feedback loop 480 detects what rules were used in the forecast, as well as the particular rules 474 and 476 that were used in the cluster control system 172 and matching system 270. It processes those rules to adjust the forecast and ordering system (e.g., at the cluster level) and the game system 270 (e.g., at the SKU-cluster interaction level). Because rule identification system 484 interacts with the mean field clustering discussed above, the interpretation engine 414 can be scaled not only in terms of the number of SKUs that are represented, but also to a large number of rules, most of which are not active. Rule identification system 484 identifies the particular rules 472 that were used in creating groups. It also identifies rules 474 that were used in generating the mean field clusters, and rules 476 that were used to generate the particular orders of individual SKUs. It can identify not only which rules where active, but their level of effectiveness. It can further detect when created clusters violate rules (such as when two different clusters have a similar risk level or similar demand level) and can modify the rules (with, for example, thresholds) if configured to do so.

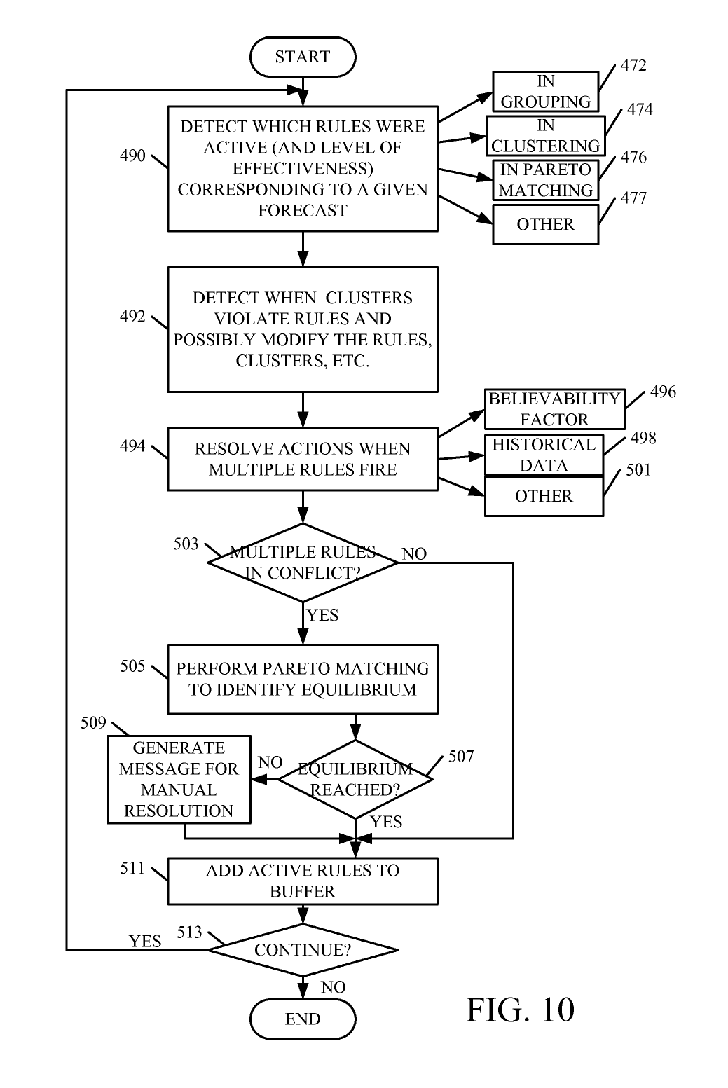

In the example shown in FIG. 9, active rule detector 406 provides the dynamics of the active rules 482 to rule identification system 484. Rule identification system 482 receives the state information from forecaster 112/optimizer 113 and identifies, based upon the dynamics 442, the various rules that were used. Loop 480 illustratively includes a pareto matching system 486, and a rule resolution component 488, and it can include the buffer of active rules 408 as well. FIG. 10 is a flow diagram illustrating one example of the operation of the feedback loops shown in FIG. 9.

Rule resolution component 488 resolves an action when multiple rules fire. It can do this by comparing a weighted average of a believability factor with an historical average, and by revising the estimated action accordingly. Rule resolution component 488 also maintains a truth value associated with each active rule, and when multiple rules have a contradiction, it invokes pareto matching system 486 to achieve a pareto equilibrium by relaxing the truth value threshold to resolve the conflict. It can minimize the amount of relaxation needed to achieve an equilibrium. If a threshold value is met (in relaxing the truth value) for which the rules can be resolved, then this means that no equilibrium can be obtained without crossing the threshold. Thus, a message can be generated and sent to the users for manual resolution of the conflict.

FIG. 10 is flow diagram illustrating one example of the operation of the system shown in FIG. 9. Rule detector 406 first detects which rules were active and, in conjunction with rule identification system 484, identifies the level of effectiveness corresponding to a given forecast. This is indicated by block 490 in FIG. 10. It can identify the particular rules 472 that were active in grouping the SKUs. It can also identify the rules 474 that were active in clustering. It can identify the rules 476 that were active during pareto matching, and it can identify other rules 477 that were active in forecasting and optimizing systems 112-113.

Loop 480 also identifies when clusters violate rules and possibly modifies the rules, the clusters, etc. This is indicated by block 492.

Rule resolution component 488 resolves actions when multiple rules fire. This is indicated by block 494. It can do this based, as discussed above, on a believability factor 496, based on historical data 498, or a combination 501.

Resolution component 482 also illustratively determines when multiple rules are in conflict, as indicated by block 503. If they are, it can perform pareto matching to identify an equilibrium, also as discussed above. This is indicated by block 505. If no equilibrium is reached at block 507, a message can be generated for manual resolution of the conflicting rules. This is indicated by block 509. It then adds the identified and active rules to buffer 408. This is indicated by block 511. If processing continues, it reverts to block 490. This is indicated by block 513.

A number of examples will now be discussed. To illustrate how the interrogation system 440 may be used in conjunction with the optimization system 113, suppose a user is asking the optimization system 113 how much to order of a certain SKU, with a rule regarding an upcoming discount from the supplier. Suppose the optimization system 113 provides a recommended order for the SKU that is much less than the amount the user was anticipating. The user queries the interrogation system 400 for an interpretation 448 to understand why the optimization system 113 made the recommendation. In this example, the interpretation 448 reports that three rules were active in obtaining the result. The three active rules were:

1. transaction history;
2. supplier has a promotion with a good discount; and
3. available space on the shelf.

The user sees that the available space on the shelf is limiting the order amount, so the user can now remove the shelf space rule and re-execute the optimization system 113. Now the suggested order increases, and the user finds an inexpensive storage location to address the shortage of shelf space.

As another example, suppose the user is planning a promotion for a certain SKU over a two week period in the user's main store, and the interrogation system 400 reports that three rules were active:

1. transaction history;
2. weather event; and
3. traffic event.

The user sees that the rules indicate an expected snowstorm during the two week period, and increased traffic around the store location, thus reducing the benefit of holding the promotion over that time period. The user then chooses another time period for the promotion, and re-executes the system.

In order to generate an interpretation 448, engine 414 can present the sequence of rules that were activated to achieve those results. For example, suppose the system suggests ordering 200 units on Tuesday for delivery on Wednesday. The interrogation system 400 might generate an interpretation 448 explaining that a special event is looming on Wednesday and a higher amount should be ordered. The interrogation system 400 will also include the ordering of soft rules, and a value representing their significance (or degree of effectiveness between zero and one) as follows:

1. (0.991) If ordering for a Mon/Tues/Wed (and no event in that time), use only historical Mon/Tues/Wed data to build the forecast.

2. (0.990) If ordering for a Sun. (and no event in that time), use only historical Sun. data to build the forecast.

3. (0.790) If ordering for a time period in which an event will occur, use historical data for that event to build the forecast.

4. (0.670) If ordering for a time period for which there will be a football event, increase the forecast for “tail-gating” items.

5. (0.670) If hot weather is predicted, increase the demand forecast for cold tea, cold coffee drinks.

6. (0.290) If offering a sale on YY, increase demand forecast for YY as well as items that are closely associated with YY. These are example scenarios only. They are provided to illustrate certain items and a wide variety of other scenarios can be used and are contemplated herein.

In one example, forecast system 112 illustratively generates a basic forecast of inventory that is desired for a particular product (e.g., a SKU). Optimization system 113 then optimizes that forecast based upon rules (or transformations) that are triggered based on trigger criteria. It will be appreciated that the present description can just as easily apply to allocation or deployment of any article being considered, such as storage capacity in a cloud-based storage system, transportation resources, treatment medicines in an epidemic region, etc. However, for purposes of example only, the description proceeds with respect to the article being a product (or SKU). Thus, system 112 generates a forecast for a SKU under consideration and optimization system 113 modifies it based on various triggered rules or transformations.

For instance, the user may be providing a promotion and therefore a rule defining the promotion may fire, and cause the inventory to be adjusted upwardly in anticipation of a higher demand, given the promotion. In another example, a weather-related rule may be set by the user that increases or decreases the inventory based upon the weather. For instance, if the user's organization sells soft drinks, it may be that the normal desired inventory is increased by a certain amount when the weather forecast is for the weather to be warm and sunny, and the inventory may be decreased by a certain amount when the weather forecast indicates that the weather is to be cold or cloudy. These are examples of rules only, and a wide variety of different rules can be applied by optimization system 113.

It will also be appreciated that a “rule” or “transformation” can also be an instruction (such as a machine instruction). The present description can be applied to such a scenario to reduce a number of instructions that are to be processed by a machine, or processor, etc.

In this way, optimization system 113 is able to take into consideration a variety of different influencing factors, and account for them in the desired inventory and order calculations. The influencing factors can include both internal and external influencing factors. An example of an internal influencing factor may be a limitation on storage space on store shelves, or in warehouse space. An example of an external influencing factor may be, as mentioned above, the weather conditions, promotional events held at a local store, price of items, events held at various facilities, etc.

When the system is processing a product (or SKU), it may be that more than one rule (or transformation) fires at the time, for a given product (or SKU) being processed. The rules may in conflict with one another. For instance, cold weather may have a negative impact on demand for soft drinks, but at the same time, an existing store promotion for soft drinks may have a positive impact on demand. Were optimization system 113 to attempt to apply all of these conflicting rules, the application would be time consuming, consume processing overhead, and could be confusing or cumbersome, resulting in erroneous orders being placed.

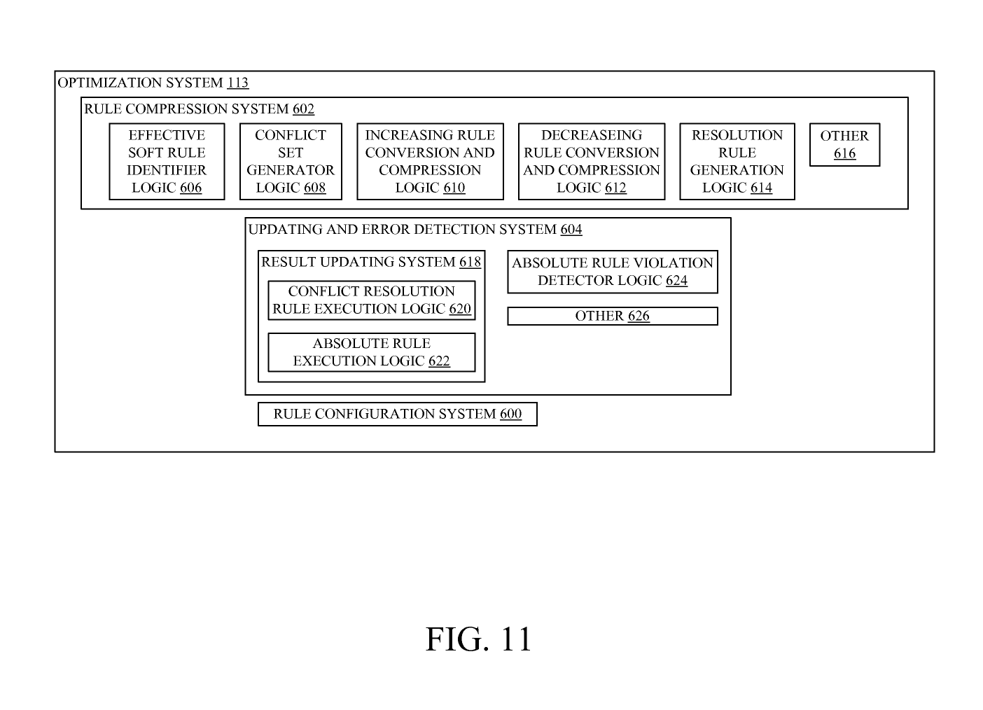

FIG. 11 shows one example of a block diagram of a portion of optimization system 113. It will be noted that the items shown in FIG. 11 can be included in forecast system 112, in interrogation system 400, or they can be spread out among those or a variety of other items in architecture 100. In the example shown in FIG. 11, optimization system 113 illustratively includes rule configuration system 600, rule compression system 602 and updating and error detection system 604.

Rule configuration system 600 illustratively generates user interface displays 104 (shown in FIG. 1) with user input mechanisms that allow user 108 to generate and/or configure various rules. The rules can be configured in a variety of different ways, and can be configured to fire or become effective under a variety of different circumstances. The rules may be external rules or internal rules such as those mentioned above. The external rules may be related to external factors, such as weather, or other external factors that may affect the sales of a particular item. The internal rules may be related to internal limitations or boundaries of the business, such as the upper and lower bounds of a given product due to limitations on storage space, etc. The rules that can be configured, can be soft rules (which means that they are conditional and apply only when triggering criteria are met), and absolute rules (meaning that they always apply). Also, the term “rule” will include “transformations” because an effective soft rule may take a basic inventory demand and transform it, by increasing it or decreasing it, to a second inventory demand. Thus, these types of “rules” will sometimes be referred to as “transformations”.

Rule compression system 602 illustratively includes effective soft rule identifier logic 606, conflict set generator logic 608, increasing rule conversion and compression logic 610, decreasing rule conversion and compression logic 612, resolution rule generation logic 614, and it can include a variety of other items 616. Effective soft rule identifier logic 606 identifies all soft rules that apply to a given SKU being processed. It may be that such rules are in conflict with one another. Therefore, conflict set generator logic 608 identifies the soft rules that may be in conflict with one another. It will be appreciated that the conflict sets can be sets of any conflicting rules. While conflicting sets of increasing and decreasing rules are described herein, that is but one example of conflict sets that can be generated. The rules may be increasing rules, which tend to increase the inventory forecast for the SKU being processed, or decreasing rules, which tend to decrease it. Increasing rule conversion and compression logic 610 illustratively compresses all effective increasing rules in the conflict set to a single increasing rule. Decreasing rule conversion and compression logic 612 illustratively compresses all effective decreasing rules in the conflict set to a single decreasing rule. Resolution rule generation logic 614 illustratively compresses the single increasing rule and the single decreasing rule into a single resolution rule that can be applied to the basic inventory.

Updating and error detection system 604 illustratively includes result updating system 618 (which, itself, illustratively includes conflict resolution rule execution logic 620 and absolute rule execution logic 622), absolute rule violation detector logic 624, and it can include other items 626. Conflict resolution rule execution logic 620 illustratively applies the resolution rule generated by resolution rule generation logic 614. Absolute rule execution logic 622 illustratively applies the absolute rules to the SKU being processed, after the conflict resolution rule has been executed (or applied). Absolute rule violation detector logic 624 illustratively determines whether any absolute rules have been violated, once the final inventory forecast has been generated.

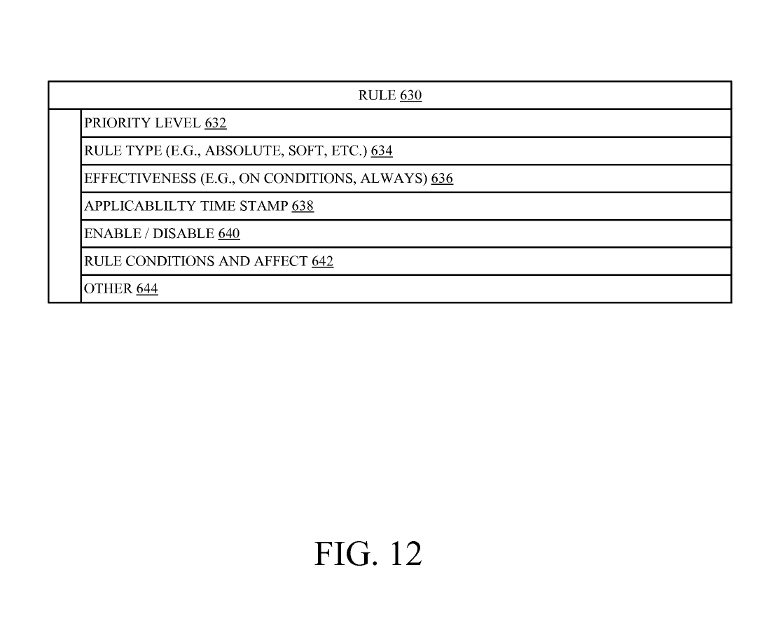

Before describing the operation of optimization system 113 (shown in FIG. 11) in more detail, a brief discussion of some examples of different rules will first be provided. FIG. 12 shows one example of items that can be included in a rule 630. The rule 630 illustratively includes a priority level property (or attribute) 632, a rule type property 634, an effectiveness property 636, an applicability time stamp 638, an enable/disable property 640, a set of rule conditions and an affect property (or an impact property) 642, and it can include other items 644. The rule priority property 632 can indicate the importance of the rule relative to other rules. In one example, the order or priority is descending (i.e., 0 being the highest priority and 1 being a lower priority). Also, in one example, valid priority levels are non-negative integers and the rules have pre-defined priority levels or they can be dynamically changing priority levels, based upon priority change criteria.

The rule type property 634 illustratively identifies whether the rule is an absolute rule of a soft rule. As mentioned above, absolute rules are unconditional rules, and have the highest priority level (e.g., priority level 0). In one example, if any absolute rules are in conflict with one another with respect to a product or SKU being processed, the conflict is surfaced for user resolution. Soft rules, as mentioned above, are conditional rules and may have an affect which increases or decreases the basic desired inventory level by some amount or percentage. Soft rules may have a priority that is greater than or equal to 1, and conflicts among effective soft rules is resolved by rule compression system 602.

The effectiveness property 636 indicates whether the conditions for triggering the associated rule are true or false. For example, a soft rule may indicate that if the forecasted weather temperature is higher than 90°, then the desired inventory of a given soft drink (such as iced tea) is to be increased by 10%. The rule is considered to be “effective” when the corresponding triggering criteria are true (e.g., when the weather temperature forecast is higher than 90° at the store location). Absolute rules are always considered to be effective, unless they are disabled (as is described below). Optimization system 113 illustratively only processes the effective rules. System functionality 136, order generation system 138 or forecast system 112 can detect whether the rules are effective, based on the rule conditions. Alternatively, this can be performed by optimization system 113.

Applicability time stamp 638 can be a user-defined time stamp which indicates a certain time period that the rule is applicable. For instance, a time stamp may indicate that a rule is only to be applied during the month of May. This is one example only.

The enable/disable property 640 illustratively allows a user to turn off or to turn on the corresponding rule. If a rule is effective, the enable/disable property 640 allows the user to explore how the effective rule influences the final result, by turning the rule on or off, and observing the change in demand forecast.

The rule conditions and effect property (or impact property) 642 illustratively define the conditions under which the rule will fire, and the impact of the rule, once it has fired (such as how the inventory forecast is to be changed).

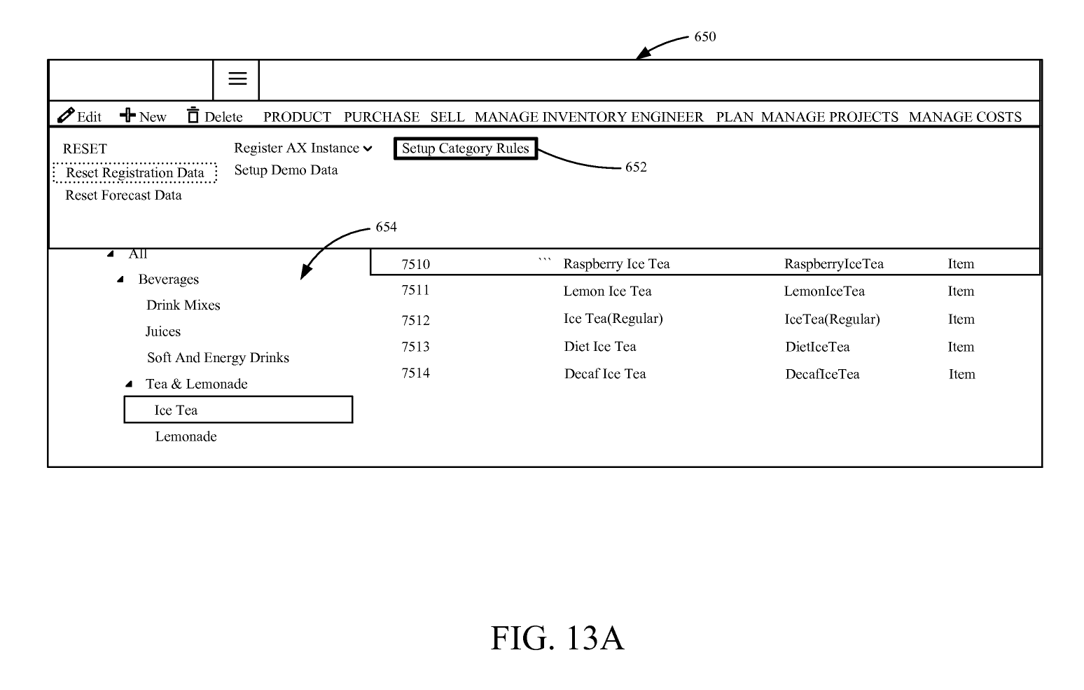

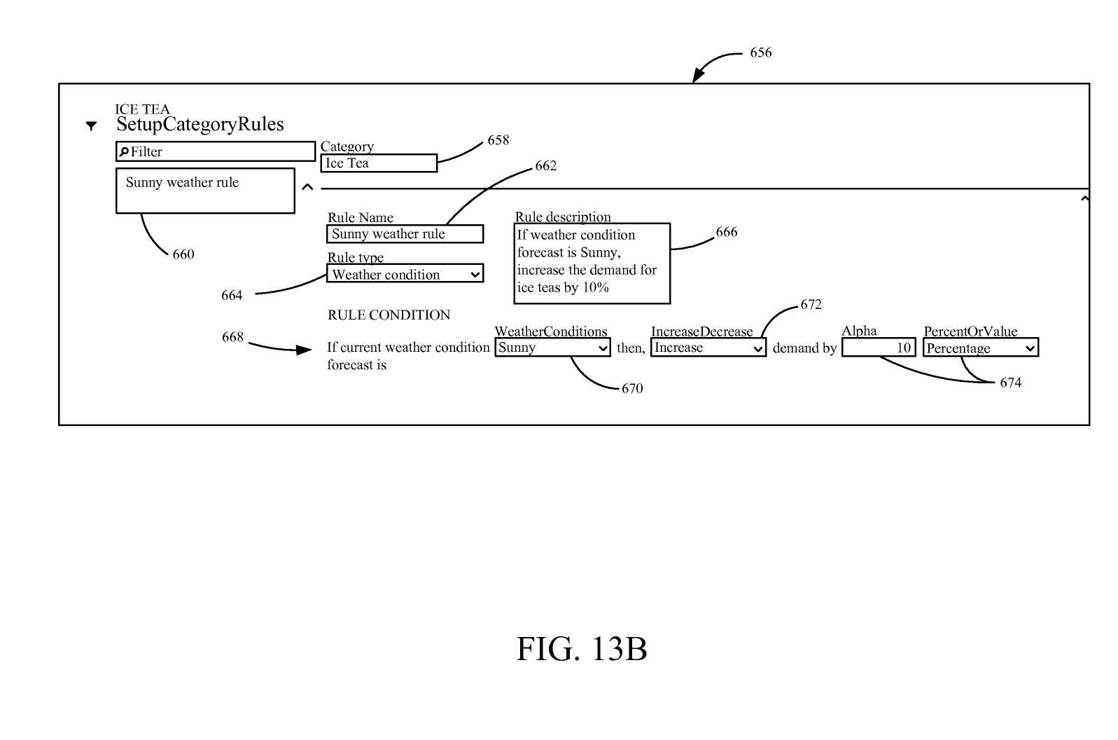

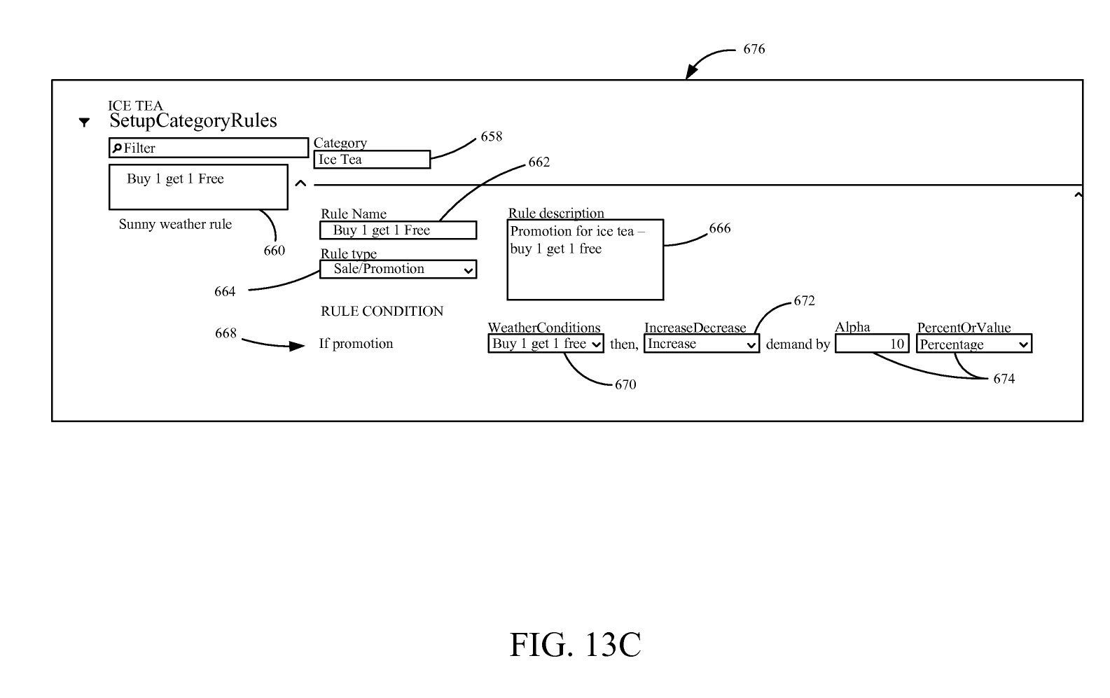

FIGS. 13A and 13B show examples of user interface displays that can be generated by rule configuration system 100, in order to allow user 108 to define one or more rules. It should also be noted that rule configuration system 600 can be located in order generation system 138, business system functionality 136, or other places as well. It is shown in optimization system 113 for the sake of example only. FIG. 13A shows one example of user interface display 650. Display 650 can be generated, for instance, by a user interface component 126 in computing system 102.

Display 650 illustratively includes a user input mechanism 652 that can be actuated in order to set up a rule. When actuated, it illustratively displays a product (or SKU) list 654 that allows the user to select a category of products or SKUs (or a single product or SKU), for which the rule is to be applied.

Once the product or category is selected, a display, such as display 656 shown in FIG. 13B, can be generated. Display 656 illustratively includes a category identifier 658 that identifies the category (or product) that was selected above in display 650. It includes a rule name portion 660 that displays the name. The name can be changed, for instance, by changing the text entered in text box 662, which defines the rule name.

Display 656 also illustratively includes a rule type selector user input mechanism 664. In the example shown, mechanism 664 is a drop down menu actuator that can be actuated to display a drop down menu, and to select a rule type from the drop down menu. In the example illustrated, the rule name is “Sunny Weather Rule”, and the rule type is a “Weather Condition” rule type.

Display 656 also illustratively includes a description portion 666 that allows the user to enter a description of the rule. The textual description entered in the example of FIG. 13B states “if weather condition forecast is sunny, increase the demand for iced teas by 10%”.

Display 656 also illustratively includes a rule condition section 668. Rule condition section 668 allows the user to actuate a weather condition user input mechanism 670 to select a weather condition under which the rule is to apply. It also includes one or more affect (or impact) actuators that allows the user to specify the affect (or impact) 672 of the rule, if the condition is met. In the example shown in FIG. 13B, the affect actuators include increase/decrease actuator 672 and amount actuator 674. The increase/decrease actuator 672 can be actuated to select whether to increase or decrease the demand of the identified product. In the example shown in FIG. 13B, the increase/decrease actuator has been actuated to set the value to “increase” the demand. The amount actuator 674 has also been actuated to set the amount at 10%. Therefore, when the rule illustrated in user interface display 656 is enabled, then if the current weather condition forecast is sunny, the demand for iced tea is to be increased by 10%.

FIG. 13C shows a user interface display 676 that can be generated to allow the user to set up a promotional rule. Some of the items are similar to those shown in FIG. 13B, and they are similarly numbered. However, it can be seen in FIG. 13C that the user has actuated the rule type actuator 654 to identify the rule as a sale/promotion rule type. The description portion 666 indicates that the rule is described as “promotion for iced tea/buy one get one free”. It also shows that the user has actuated the condition user input mechanism 670 to select a “Buy One Get One Free” condition. Actuator 672 has been actuated to specify that when such a promotion is present or currently active, the demand forecast should be increased. Actuator 674 has been actuated to indicate that the amount of the increase should be 10%. Therefore, if the current store is running a “Buy One Get One Free” promotion, then the demand for iced tea is to be increased by 10%.

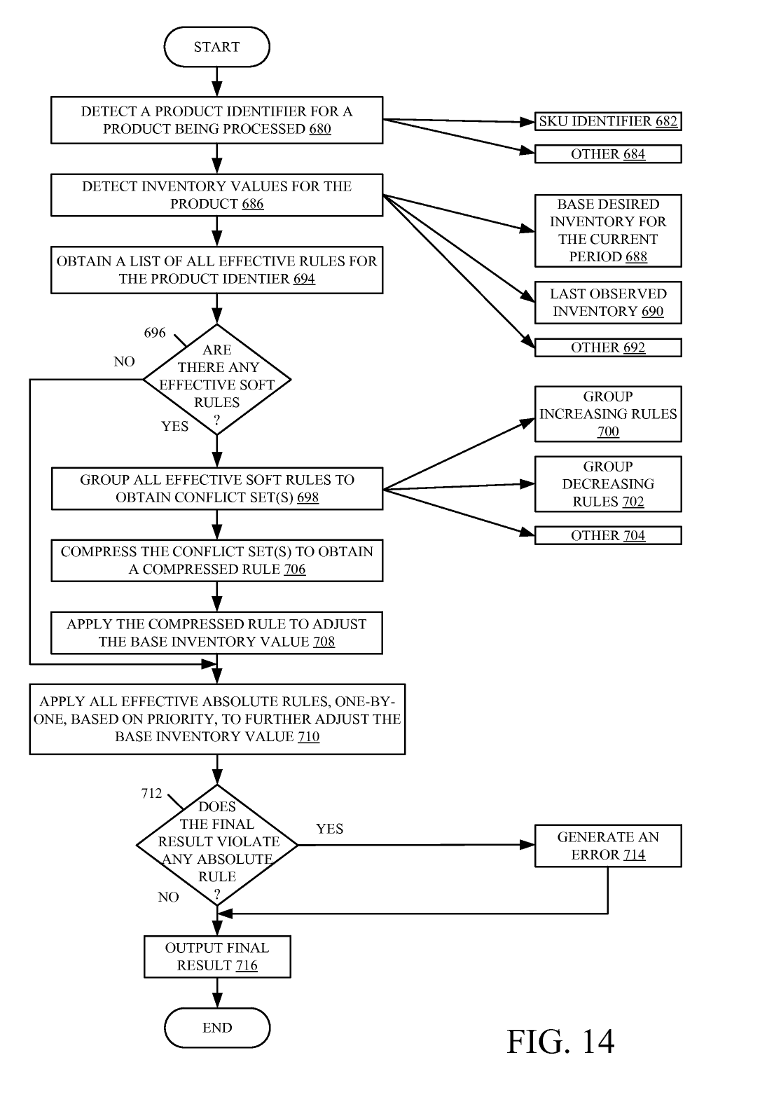

FIG. 14 is a flow diagram showing one example of how optimization system 113 in FIG. 11 operates. It is first assumed that rule compression system 106 detects (or receives) a product identifier for a product being processed by forecast system 112. This is indicated by block 680 in FIG. 14. The product identifier can be a SKU identifier 682 or another product identifier 684.

Updating and error detection system 604 also illustratively detects (or otherwise obtains) inventory values for the product being processed. This is indicated by block 686. The inventory values can include the base desired inventory for this product, for a current period of time. This is indicated by block 688. It can also include the last observed, actual inventory value, as indicated by block 690. It can include a wide variety of other things 692 as well.

Effective soft rule identifier logic 606 then obtains a list of all effective rules for the product identifier. This is indicated by block 694. In one example, it is the identifier logic 606, itself, that identifies whether any rules are effective (such as whether there are absolute rules with respect to the product being processed, or whether the conditions for any soft rules have been met, for the product being processed). In another example, it is the responsibility of business system functionality 136 or order generation system 138 in computing system 102 to generate the list of effective rules for the product identifier.

In either case, effective soft rule identifier logic 606 determines whether there are any effective soft rules. This is indicated by block 696. If so, then conflict set generator logic 608 groups all of the effective soft rules to obtain one or more conflict sets of rules. This is indicated by block 698. In one example, all of the effective soft rules that would increase the desired inventory are grouped into a set and all of the effective soft rules that would decrease inventory are grouped into a second set. This is indicated by blocks 700 and 702 in FIG. 14. The rules can be grouped in other ways as well, as indicated by block 704.

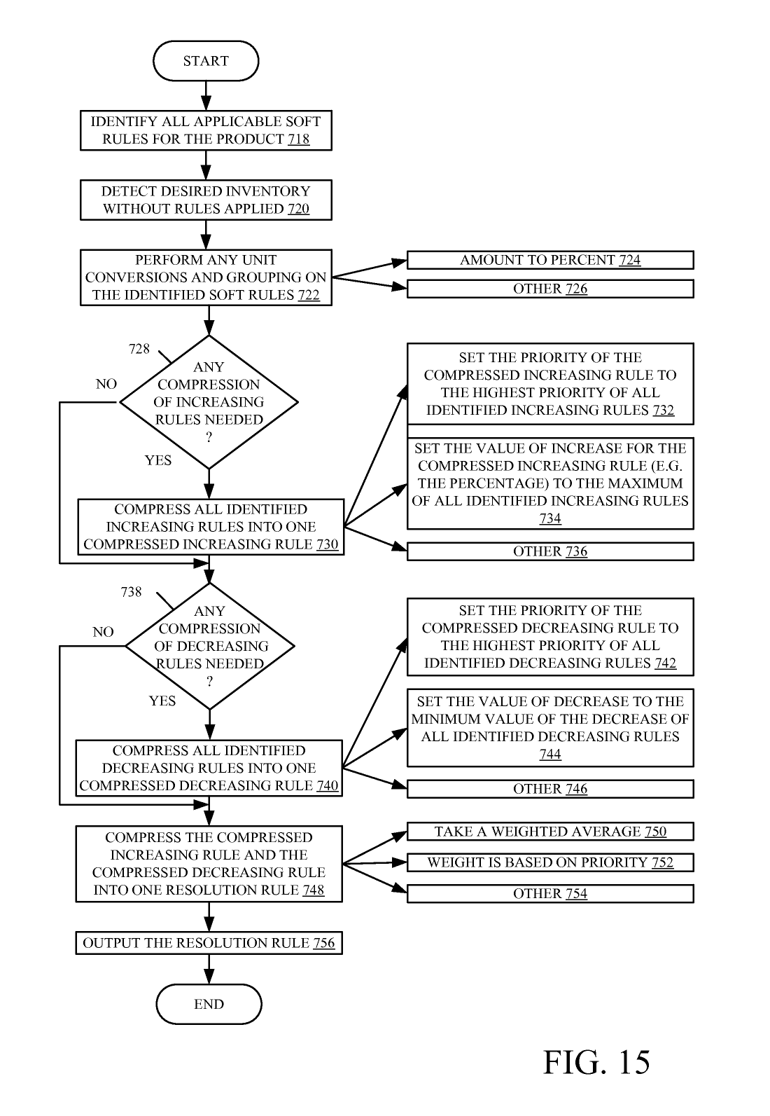

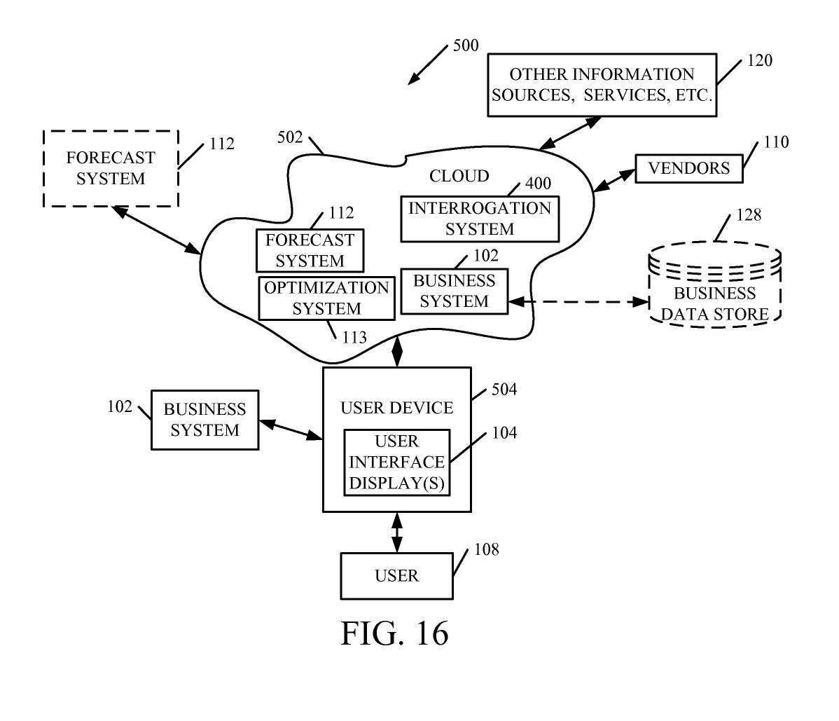

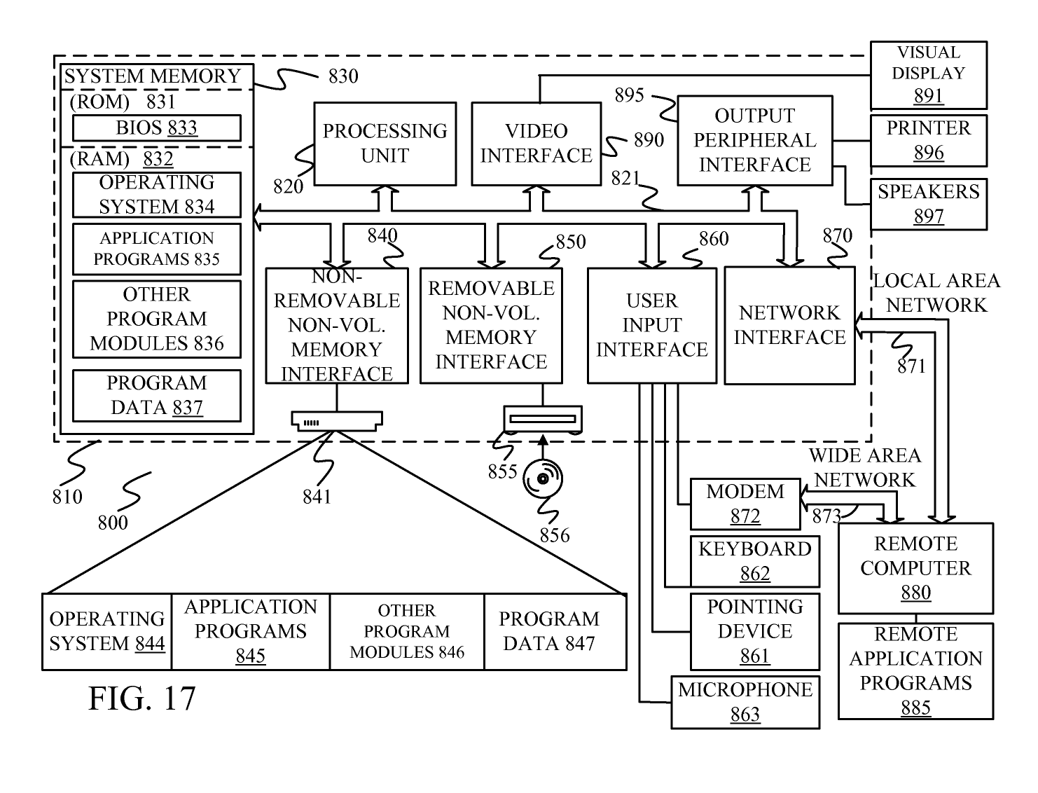

Rule compression system 602 then compresses the conflict sets to obtain a compressed rule. This is indicated by block 706. In one example, as is described in greater detail below with respect to FIG. 15, increasing rule conversion and compression logic 610 compresses the increasing rules to obtain a single increasing rule, and decreasing rule conversion and compression logic 612 compresses the decreasing rules to obtain a single decreasing rule. Then, resolution rule generation logic 614 compresses the increasing and decreasing rules to obtain a single resolution rule.

Conflict resolution rule execution logic 620 then applies the single, compressed rule to adjust the base inventory value. This is indicated by block 708.

Absolute rule execution logic 622 then applies all effective absolute rules, one by one, based upon their priority, to further adjust the base inventory value. This is indicated by block 710.

Absolute rule violation detector logic 624 then determines whether the final result of the base inventory value (as adjusted) violates any of the absolute rules. This is indicated by block 712. For example, if one absolute rule sets the minimum inventory level to be at least 20, then absolute rule violation detector logic 624 checks the desired inventory level output, as adjusted, to see if it is less than 20. If so, absolute rule execution logic 622 then sets the level to 20.

Absolute rule violation detector logic 624 then detects whether the final result violates any absolute rule. If any violation is detected, then violation detector logic 624 generates an error as indicated by block 714. The error can be provided to order generation system 138 or business system functionality 136 in computing system 102, where it can be surfaced using user interface component 126 for user 108. User 108 can then resolve the conflict as desired.

Regardless of whether a conflict is identified, the final inventory result can be output, as indicated by block 716. In one example, if an error exists, the final result can be output, along with an indication of the error. In another example, where an error exists, then the final result is not output, and only the error is surfaced for the user.

FIG. 15 is a flow diagram illustrating one example of the operation of rule compression system 602, in more detail. Effective soft rule identifier logic 606 identifies all of the applicable soft rules for the product or SKU being processed. This is indicated by block 718 in FIG. 15. The identity of those rules can be provided to identifier logic 606 from other parts of optimization system 113, from forecast system 112, or from items in computing system 102 that evaluate the triggering conditions for the various soft rules. Alternatively, logic 606 can, itself, identify which rules are effective, based upon the triggering conditions. Updating and error detection system 614 also detects (or otherwise obtains) the desired inventory level for the product or SKU being processed, without any of the optimization rules being applied. This is indicated by block 720. Again, that value can be accessed directly by system 614, or it can be provided to system 614 from other components in architecture 100.

Conflict set generator logic 608 then groups all increasing rules and all decreasing rules into separate groups. This is indicated by block 724 and these groups are referred to as conflict sets. It can perform grouping in other ways as well, and this indicated by block 726. Increasing rule conversion and compression logic 610 and decreasing rule conversion and compression logic 612 then perform any unit conversions on the identified soft rules that are effective, in the corresponding conflict set. This is indicated by block 722. For instance, the increasing and decreasing types of soft rules contained in the conflict set may not be the same. One rule may increase by a “quantity or amount”, while the second increases or decreases by a “percentage”. Therefore, logic 610 and logic 612 first convert the rules to the same units (although this can also be done by a single converter). In one example, it may convert the amount type into “percentage” by dividing the original amount value by the basic inventory value (e.g., the original desired inventory value without any adjustment by any rule) or the item or SKU being considered. One example of this is indicated in equation 59 below.

$$Value = \frac{original value in amount}{basic desired inventory} \times 100 \qquad Eq . 59$$

If there are any increasing rules identified, then it is determined whether any compression of those rules is needed. For instance, if there are two or more increasing rules, then they are to be compressed into a single increasing rule. This is indicated by blocks 728 and 730. This can take a variety of different forms. In one example, increasing rule conversion and compression logic 610 first sets the priority of the compressed increasing rule to the highest priority of all of the identified increasing rules in the conflict set. This is indicated by block 732. It then sets the value of increase for the compressed increasing rule (e.g., the percentage of increase) identified by the rule's impact property to the maximum of all percentages in the identified increasing rules in the conflict set. This is indicated by block 734. This will be the final compressed increasing rule output by increasing rule conversion and compression logic 610. It will be noted that the increasing rules can be compressed in other ways as well, and this is indicated by block 736.

Decreasing rule conversion and compression logic 612 then determines whether any compression of decreasing rules is needed. This is the case, for instance, where there are two or more effective decreasing rules for the current SKU or product. This is indicated by block 738. If so, then logic 612 compresses all identified decreasing rules into one compressed decreasing rule. This is indicated by block 740. In one example, it sets the priority level of the compressed decreasing rule to the highest priority of all identified decreasing rules. This is indicated by block 742. It then sets the value of decrease to the minimum value of decrease of all of the identified decreasing rules in the conflict set (as identified by the impact property). This is indicated by block 744. This will be the compressed decreasing rule output by logic 612. It can compress the decreasing rules in other ways as well, and this is indicated by block 746.

Resolution rule generation logic 614 then compresses the compressed increasing rule and the compressed decreasing rule into a single, compressed resolution rule that is to be applied. This is indicated by block 748. It can do so, for instance, by taking a weighted average of the two compressed rules (e.g., the compressed increasing rule and the compressed decreasing rule). This is indicated by block 750. The weight can be based on the priority of those rules, as indicated by block 752. The single, compressed resolution rule can be generated in other ways as well, as indicated by block 754.

Equations 60-62 show one example of how the two rules are compressed into a single resolution rule by taking the weighted average.

$$\begin{matrix}weighted avergage = \frac{\begin{matrix}( weight * value ) of converted increasing rule - \\ ( weight * value ) of converted decreasing rule\end{matrix}}{\begin{matrix}weight of converted increasing rule + \\ weight of converted decreasing rule\end{matrix}} \\ Where & Eq . 60 \\ weight of converted increasing rule = \frac{1}{\begin{matrix}Priority level of \\ converted increasing rule\end{matrix}} & Eq . 61 \\ weight of converted decreasing rule = \frac{1}{\begin{matrix}Priority level of \\ converted decreasing rule\end{matrix}} & Eq . 62\end{matrix}$$

Resolution rule generation logic 614 then outputs the final resolution rule, as indicated by block 756. Conflict resolution rule logic 620 (shown in FIG. 11) can then be used to apply that resolution rule to the inventory demand.

Table 2 below shows one example of pseudo code that can be used to perform the soft rule compression discussed above. Table 3 below shows one example of pseudo code that can be used to apply a soft rule (either a single soft rule, or the final resolution rule that is the compressed form of all of the effective soft rules).

TABLE 2
Code for soft rules conflict resolution

def soft_rules_conflict_resolution(soft_rules):

‘“
Function to resolve conflicts in soft_rules to calculate value resolution for a given SKU.
Input: soft_rules − DataFrame (columns = RuleID, rule-level (sku/group), rule-priority, rule-type (%, #,

‘ub’,‘lb’,‘fixed’), value, groupid, skuid,GlobalParameters.DataLabels.INCREASE_OR_DECREASE) contains the active
soft rules for a given SKU.

Output: value resolution of conflicting soft rules for a given SKU.
’”
priority_increase = 1
value_increase = 0
# check if any incereasing rules exist.
if len(soft_rules[soft_rules[GlobalParameters.DataLabels.INCREASE_OR_DECREASE] == ‘increase’]):

priority_increase = min(soft_rules[soft_rules[GlobalParameters.DataLabels.INCREASE_OR_DECREASE] ==

‘increase’][GlobalParameters.DataLabels.RULE_PRIORITY])

value_increase = max(soft_rules[soft_rules[GlobalParameters.DataLabels.INCREASE_OR_DECREASE] ==

‘increase’][GlobalParameters.DataLabels.RULE_VALUE])

priority_decrease = 1
value_decrease = 0
# check if any decreasing rules exist.
if len(soft_rules[soft_rules[GlobalParameters.DataLabels.INCREASE_OR_DECREASE] == ‘decrease’]):

priority_decrease = min(soft_rules[soft_rules[GlobalParameters.DataLabels.INCREASE_OR_DECREASE] ==

‘decrease’][GlobalParameters.DataLabels.RULE_PRIORITY])

value_decrease = min(soft_rules[soft_rules[GlobalParameters.DataLabels.INCREASE_OR_DECREASE] ==

‘decrease’][GlobalParameters.DataLabels.RULE_VALUE])

if value_decrease == 0:

weight_decrease = 0

else:

weight_decrease = 1/priority_decrease

if value_increase == 0:

weight_increase = 0

else:

weight_increase = 1/priority_increase

value_resolution = (weight_increase * value_increase − weight_decrease * value_decrease)/(weight_decrease +

weight_increase)

return value_resolution

TABLE 3
Code for applying soft rules

def apply_soft_rules(forecast_result, soft_rules):

‘“
Function to apply soft rules to calculate final demand with soft rules applied.
Input: forecast_result − DataFrame (columns = SKUID, demand_no_rule, final_demand, desired_inventory,

suggested_order) containing demand forecast and suggested order.

soft_rules − DataFrame (columns = RuleID, rule-level (sku/group), rule-priority, rule-type (%, #,

‘ub’,‘lb’,‘fixed’), value, groupid, skuid,GlobalParameters.DataLabels.INCREASE_OR_DECREASE) contains the active
rules.

Output: forecast_result − DataFrame (columns = SKUID, demand_no_rule, final_demand, desired_inventory,

suggested_order) containing demand forecast and suggested order.

’”
# All soft_rules are at sku level
# All rules received by this function are for a single sku.
value_resolution = soft_rules_conflict_resolution(soft_rules)
sku_final_demand = (1 + value_resolution) / 100 *

forecast_result[GlobalParameters.DataLabels.DEMAND_BEFORE_RULES][j]

forecast_result[forecast_result[GlobalParameters.DataLabels.SKUID] ==

soft_rules[GlobalParameters.DataLabels.SKUID]][GlobalParameters.DataLabels.FINAL_DEMAND] =
sku_final_demand

return forecast_result

An example will now be described to further enhance understanding. It is first assumed that the effective increasing and decreasing rules that are being considered are those shown in Table 4 below. It should be borne in mind, again, that the priority level is from lowest to highest. Therefore, the priority 1 level rules are higher priority than the priority 2 or priority 3 level rules, etc.

TABLE 4

| Effective Soft | Priority | | | |
|---|---|---|---|---|
| Rule ID | Level | Increase or Decrease | Type | Value |
| R1 | 1 | Increase | Percentage | 10 |
| R2 | 2 | Increase | Percentage | 25 |
| R3 | 3 | Decrease | Percentage | 20 |
| R4 | 3 | Decrease | Percentage | 5 |
| R5 | 3 | Decrease | Percentage | 30 |

In order to compress the five conflicting rules shown in Table 1, it is first worth noting that the affect property is already expressed in percentage for all effective rules so no conversion is needed. Then, rules R1 and R2 are grouped together, because they are both “increasing” rules, and rules R3-R5 are grouped together because they are all “decreasing” rules. The compressed increasing rule (the compressed form of rules R1 and R2) will have its impact property set to indicate that the value of increase is 25 percent (because it is the maximum increase of those two rules) with its priority property set to 1 (because it is the highest priority of those two rules). The three decreasing rules all have the same priority, therefore the compressed form of those rules will have a priority property set to 3, and the impact property set to indicate that the value of decrease will be 5 percent. This is because rule 4 has the smallest value of decrease (5 percent) of the three decreasing rules.

Table 5 now shows that the five conflicting rules have been compressed into two rules, one compressed increasing rule and one compressed decreasing rule.

TABLE 5

| | | Increase or | | |
|---|---|---|---|---|
| Soft Rules | Priority Level | Decrease | Type | Value |
| converted increasing | 1 | Increase | Percentage | 25 |
| converted decreasing | 3 | Decrease | Percentage | 5 |

These two conflicting rules are further compressed by taking a weighted average, with the weight of the converted increasing rule set to be 1 and the weight of the converted decreasing rule set to be 3, as follows:

$$\begin{matrix}weighted average = \frac{1 / 1}{1 + 1 / 3} \times 25 \% - \frac{1 / 3}{1 + 1 / 3} \times 5 \% \\ = 17.5 \%\end{matrix} \qquad Eq . 63$$

This provides the final resolution rule. Thus, the five rules shown in Table 4 are compressed into a single compressed resolution rule which indicates that the basic inventory value is to be increased by 17.5%.

It will also be noted that, in one example, optimization system 113 keeps interrogation system 400 apprised of the various values that are generated therein. For instance, it can first record the basic desired inventory value and then the effective soft rules, if there are any that are being applied. It can record the resolution rule, if there is one, and it can also record the adjusted desired inventory if the adjustment is applied. It can record each applied absolute rule as well as the desired inventory before and after the rule is applied, and it can record any error that is generated based on a violation of any effective absolute rules. These are examples only.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

FIG. 11 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 11, some items are similar to those shown in FIG. 1 and they are similarly numbered. FIG. 11 specifically shows that computing system 102, and forecast system 112, optimization system 113 and interrogation system 400 can be located in cloud 502 (which can be public, private, or a combination where portions are public while others are private). Therefore, user 108 uses a user device 504 to access those systems through cloud 502.

FIG. 11 also depicts another example of a cloud architecture. FIG. 11 shows that it is also contemplated that some elements of architecture 100 can be disposed in cloud 502 while others are not. By way of example, data store 128 can be disposed outside of cloud 502, and accessed through cloud 502. In another example, business system 102 can be an on premise business system and forecast system 112, optimization system 113 and/or interrogation system 400 can be cloud-based services or reside in another remote server location. It could be local to business system 102 as well. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

FIG. 12 is one embodiment of a computing environment in which architecture 100, or parts of it, (for example) can be deployed. With reference to FIG. 12, an exemplary system for implementing some embodiments includes a general-purpose computing device in the form of a computer 810. Components of computer 810 may include, but are not limited to, a processing unit 820 (which can comprise processor 124 or 402 or controller 268 or others), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein (such as that in cluster deconstruction component 174 or other items in forecast system 112) can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

conflict set generator logic that generates a conflict set of effective, conflicting transformations that transform a first quantity identifier identifying a first quantity of a product into a second quantity identifier identifying a second quantity of the product, each conflicting transformation in the conflict set having a corresponding transformation priority property that identifies a priority of the corresponding transformation relative to other transformations and an affect property that identifies how the first quantity identifier of the product is transformed into the second quantity identifier;

a compression system that compresses the conflict set of conflicting transformations into a single resolution transformation, that has a resolution affect property, based on the priority property and the affect property corresponding to each transform in the conflict set;

an updating system that applies the resolution transformation to the first quantity identifier and transforms the first quantity identifier into an adjusted quantity identifier, based on the resolution affect property; and

an order generation system that generates a quantity order for the product based on the adjusted quantity identifier.

Example 2 is the computing system of any or all previous examples wherein the conflict set generator logic identifies increasing transformations, that have a corresponding affect property that increases the first quantity identifier, as an increasing transformation conflict set and identifies decreasing transformations, that have a corresponding affect property that decreases the first quantity identifier, as a decreasing transformation conflict set.

Example 3 is the computing system of any or all previous examples wherein the compression system comprises:

increasing transformation compression logic that compresses the increasing transformations in the increasing transformation conflict set into a single, compressed increasing transformation.

Example 4 is the computing system of any or all previous examples wherein the compression system comprises:

decreasing transformation compression logic that compresses the decreasing transformations in the decreasing transformation conflict set into a single, compressed decreasing transformation.

Example 5 is the computing system of any or all previous examples wherein the compression system comprises:

resolution transformation compression logic that compresses the single, compressed increasing transformation and the single, compressed decreasing transformation into the single resolution transformation based on a priority property and affect property corresponding to each of the single, compressed increasing transformation and the single, compressed decreasing transformation.

Example 6 is the computing system of any or all previous examples wherein the increasing transformation compression logic generates the single, compressed increasing transformation with an increasing affect property that is a maximum of the affect properties corresponding to any of the increasing transformations in the increasing transformation conflict set.

Example 7 is the computing system of any or all previous examples wherein the increasing transformation compression logic generates the single, compressed increasing transformation with a priority property that identifies a highest priority of the priority properties corresponding to any of the increasing transformations in the increasing transformation conflict set.

Example 8 is the computing system of any or all previous examples wherein the decreasing transformation compression logic generates the single, compressed decreasing transformation with a decreasing affect property that is a minimum of the affect properties corresponding to any of the decreasing transformations in the decreasing transformation conflict set.

Example 9 is the computing system of any or all previous examples wherein the decreasing transformation compression logic generates the single, compressed decreasing transformation with a priority property that identifies a highest priority of the priority properties corresponding to any of the decreasing transformations in the decreasing transformation conflict set.

Example 10 is the computing system of any or all previous examples wherein the resolution transformation compression logic generates the single resolution transformation as a weighted average of the single, compressed increasing transformation and the single, compressed decreasing transformation based on the priority properties corresponding to the single, compressed increasing transformation and the single, compressed decreasing transformation.

Example 11 is the computing system of any or all previous examples wherein the transformations in the conflict set are conditional transformations that become effective based on triggering conditions, application of the resolution transformation providing a second quantity, and further comprising:

absolute rule execution logic that executes any enabled absolute rules, with a corresponding absolute affect property, on the second quantity identifier to obtain the adjusted quantity identifier.

Example 12 is the computing system of any or all previous examples, and further comprising:

absolute rule violation detector logic that determines whether the adjusted quantity identifier violates any enabled, absolute rules and, if so, surfaces an error indicator.

Example 13 is a computer implemented method, comprising:

generating a conflict set of effective, conflicting transformations that transform a first quantity identifier identifying a first quantity of a product into a second quantity identifier identifying a second quantity of the product, each conflicting transformation in the conflict set having a corresponding transformation priority property that identifies a priority of the corresponding transformation relative to other transformations and an affect property that identifies how the first quantity identifier of the product is transformed into the second quantity identifier;

compressing the conflict set of conflicting transformations into a single resolution transformation, that has a resolution affect property, based on the priority property and the affect property corresponding to each transform in the conflict set;

transforming the first quantity identifier into an adjusted quantity identifier with the resolution transformation, based on the resolution affect property; and

generating a quantity order for the product based on the adjusted quantity identifier.

Example 14 is the computer implemented method of claim 13 wherein generating a conflict set comprises:

identifying increasing transformations, that have a corresponding affect property that increases the first quantity identifier, as an increasing transformation conflict set; and

identifying decreasing transformations, that have a corresponding affect property that decreases the first quantity identifier, as a decreasing transformation conflict set.

Example 15 is the computer implemented method of any or all previous examples wherein compressing the conflict set comprises:

compressing the increasing transformations in the increasing transformation conflict set into a single, compressed increasing transformation; and

compressing the decreasing transformations in the decreasing transformation conflict set into a single, compressed decreasing transformation.

Example 16 is the computer implemented method of any or all previous examples wherein compressing the conflict set comprises:

compressing the single, compressed increasing transformation and the single, compressed decreasing transformation into the single resolution transformation based on a priority property and affect property corresponding to each of the single, compressed increasing transformation and the single, compressed decreasing transformation.

Example 17 is the computer implemented method of any or all previous examples wherein compressing the conflict set comprises:

generating the single, compressed increasing transformation with an increasing affect property that is a maximum of the affect properties corresponding to any of the increasing transformations in the increasing transformation conflict set and with a priority property that identifies a highest priority of the priority properties corresponding to any of the increasing transformations in the increasing transformation conflict set; and

generating the single, compressed decreasing transformation with a decreasing affect property that is a minimum of the affect properties corresponding to any of the decreasing transformations in the decreasing transformation conflict set and with a priority property that identifies a highest priority of the priority properties corresponding to any of the decreasing transformations in the decreasing transformation conflict set.

Example 18 is the computer implemented method of any or all previous examples wherein the resolution transformation compression logic generates the single resolution transformation as a weighted average of the single, compressed increasing transformation and the single, compressed decreasing transformation based on the priority properties corresponding to the single, compressed increasing transformation and the single, compressed decreasing transformation.

Example 19 is a computing system, comprising:

conflict set generator logic that generates an increasing transformation conflict set of effective, conflicting increasing transformations and a decreasing transformation conflict set of effective, conflicting decreasing transformations, each of the increasing transformations and decreasing transformations transforming a first quantity identifier identifying a first quantity of a product into a second quantity identifier identifying a second quantity of the product, each of the increasing and decreasing transformations having a corresponding transformation priority property that identifies a priority of the corresponding transformation relative to other transformations and an affect property that identifies how the first quantity identifier of the product is transformed into the second quantity identifier;

increasing transformation compression logic that compresses the increasing transformations in the increasing transformation conflict set into a single, compressed increasing transformation;

decreasing transformation compression logic that compresses the decreasing transformations in the decreasing transformation conflict set into a single, compressed decreasing transformation;

resolution transformation compression logic that compresses the single, compressed increasing transformation and the single, compressed decreasing transformation into a single resolution transformation with a resolution affect property based on the corresponding priority property and affect property corresponding to each of the single, compressed increasing transformation and the single, compressed decreasing transformation;

an updating system that applies the resolution transformation to the first quantity identifier and transforms the first quantity identifier into an adjusted quantity identifier, based on the resolution affect property; and

an order generation system that surfaces a quantity order for the product based on the adjusted quantity identifier.

Example 20 is the computing system of any or all previous examples wherein the transformations in the increasing and decreasing transformation conflict sets are conditional transformations that become effective based on triggering conditions, wherein application of the resolution transformation provides a second quantity, and further comprising:

absolute rule execution logic that executes any enabled absolute rules, with a corresponding absolute affect property, on the second quantity identifier to obtain the adjusted quantity identifier; and

absolute rule violation detector logic that determines whether the adjusted quantity identifier violates any enabled, absolute rules and, if so, surfaces an error indicator.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
conflict set generator logic that obtains a conflict set of effective, conflicting transformations that transform a first quantity identifier identifying a first quantity of an article into a second quantity identifier identifying a second quantity of the article, each conflicting transformation in the conflict set having a corresponding transformation priority property that identifies a priority of the corresponding transformation relative to other transformations and an impact property that identifies how the first quantity identifier of the article is transformed into the second quantity identifier;
a compression system that compresses the conflict set of conflicting transformations into a single resolution transformation, that has a resolution impact property, based on the priority property and the impact property corresponding to each transform in the conflict set;
an updating system that applies the resolution transformation to the first quantity identifier and transforms the first quantity identifier into an adjusted quantity identifier, based on the resolution impact property; and
an order generation system that generates a quantity order for the article based on the adjusted quantity identifier.

2. The computing system of claim 1 wherein the conflict set generator logic identifies increasing transformations, that have a corresponding impact property that increases the first quantity identifier, as an increasing transformation conflict set and identifies decreasing transformations, that have a corresponding impact property that decreases the first quantity identifier, as a decreasing transformation conflict set.

3. The computing system of claim 2 wherein the compression system comprises:
increasing transformation compression logic that compresses the increasing transformations in the increasing transformation conflict set into a single, compressed increasing transformation.

4. The computing system of claim 3 wherein the compression system comprises:
decreasing transformation compression logic that compresses the decreasing transformations in the decreasing transformation conflict set into a single, compressed decreasing transformation.

5. The computing system of claim 4 wherein the compression system comprises:
resolution transformation compression logic that compresses the single, compressed increasing transformation and the single, compressed decreasing transformation into the single resolution transformation based on a priority property and impact property corresponding to each of the single, compressed increasing transformation and the single, compressed decreasing transformation.

6. The computing system of claim 5 wherein the increasing transformation compression logic generates the single, compressed increasing transformation with an increasing impact property that is a maximum of the affect properties corresponding to any of the increasing transformations in the increasing transformation conflict set.

7. The computing system of claim 6 wherein the increasing transformation compression logic generates the single, compressed increasing transformation with a priority property that identifies a highest priority of the priority properties corresponding to any of the increasing transformations in the increasing transformation conflict set.

8. The computing system of claim 7 wherein the decreasing transformation compression logic generates the single, compressed decreasing transformation with a decreasing impact property that is a minimum of the impact properties corresponding to any of the decreasing transformations in the decreasing transformation conflict set.

9. The computing system of claim 8 wherein the decreasing transformation compression logic generates the single, compressed decreasing transformation with a priority property that identifies a highest priority of the priority properties corresponding to any of the decreasing transformations in the decreasing transformation conflict set.

10. The computing system of claim 9 wherein the resolution transformation compression logic generates the single resolution transformation as a weighted average of the single, compressed increasing transformation and the single, compressed decreasing transformation based on the priority properties corresponding to the single, compressed increasing transformation and the single, compressed decreasing transformation.

11. The computing system of claim 10 wherein the transformations in the conflict set are conditional transformations that become effective based on triggering conditions, application of the resolution transformation providing a second quantity, and further comprising:
absolute rule execution logic that executes any enabled absolute rules, with a corresponding absolute impact property, on the second quantity identifier to obtain the adjusted quantity identifier.

12. The computing system of claim 11, and further comprising:
absolute rule violation detector logic that determines whether the adjusted quantity identifier violates any enabled, absolute rules and, if so, surfaces an error indicator.

13. A computer implemented method, comprising:
obtaining a conflict set of effective, conflicting transformations that transform a first quantity identifier identifying a first quantity of an article into a second quantity identifier identifying a second quantity of the article, each conflicting transformation in the conflict set having a corresponding transformation priority property that identifies a priority of the corresponding transformation relative to other transformations and an impact property that identifies how the first quantity identifier of the article is transformed into the second quantity identifier;
compressing the conflict set of conflicting transformations into a single resolution transformation, that has a resolution impact property, based on the priority property and the impact property corresponding to each transform in the conflict set;
transforming the first quantity identifier into an adjusted quantity identifier with the resolution transformation, based on the resolution impact property; and
generating a quantity order for the article based on the adjusted quantity identifier.

14. The computer implemented method of claim 13 wherein generating a conflict set comprises:
identifying increasing transformations, that have a corresponding impact property that increases the first quantity identifier, as an increasing transformation conflict set; and
identifying decreasing transformations, that have a corresponding impact property that decreases the first quantity identifier, as a decreasing transformation conflict set.

15. The computer implemented method of claim 14 wherein compressing the conflict set comprises:
compressing the increasing transformations in the increasing transformation conflict set into a single, compressed increasing transformation; and
compressing the decreasing transformations in the decreasing transformation conflict set into a single, compressed decreasing transformation.

16. The computer implemented method of claim 15 wherein compressing the conflict set comprises:
compressing the single, compressed increasing transformation and the single, compressed decreasing transformation into the single resolution transformation based on a priority property and impact property corresponding to each of the single, compressed increasing transformation and the single, compressed decreasing transformation.

17. The computer implemented method of claim 16 wherein compressing the conflict set comprises:
generating the single, compressed increasing transformation with an increasing impact property that is a maximum of the impact properties corresponding to any of the increasing transformations in the increasing transformation conflict set and with a priority property that identifies a highest priority of the priority properties corresponding to any of the increasing transformations in the increasing transformation conflict set; and
generating the single, compressed decreasing transformation with a decreasing impact property that is a minimum of the impact properties corresponding to any of the decreasing transformations in the decreasing transformation conflict set and with a priority property that identifies a highest priority of the priority properties corresponding to any of the decreasing transformations in the decreasing transformation conflict set.

18. The computer implemented method of claim 17 wherein the resolution transformation compression logic generates the single resolution transformation as a weighted average of the single, compressed increasing transformation and the single, compressed decreasing transformation based on the priority properties corresponding to the single, compressed increasing transformation and the single, compressed decreasing transformation.

19. A computing system, comprising:
conflict set generator logic that obtains an increasing transformation conflict set of effective, conflicting increasing transformations and a decreasing transformation conflict set of effective, conflicting decreasing transformations, each of the increasing transformations and decreasing transformations transforming a first quantity identifier identifying a first quantity of an aticle into a second quantity identifier identifying a second quantity of the article, each of the increasing and decreasing transformations having a corresponding transformation priority property that identifies a priority of the corresponding transformation relative to other transformations and an impact property that identifies how the first quantity identifier of the product is transformed into the second quantity identifier;
increasing transformation compression logic that compresses the increasing transformations in the increasing transformation conflict set into a single, compressed increasing transformation;
decreasing transformation compression logic that compresses the decreasing transformations in the decreasing transformation conflict set into a single, compressed decreasing transformation;
resolution transformation compression logic that compresses the single, compressed increasing transformation and the single, compressed decreasing transformation into a single resolution transformation with a resolution impact property based on the corresponding priority property and impact property corresponding to each of the single, compressed increasing transformation and the single, compressed decreasing transformation;
an updating system that applies the resolution transformation to the first quantity identifier and transforms the first quantity identifier into an adjusted quantity identifier, based on the resolution impact property; and
an order generation system that surfaces a quantity order for the article based on the adjusted quantity identifier.

20. The computing system of claim 19 wherein the transformations in the increasing and decreasing transformation conflict sets are conditional transformations that become effective based on triggering conditions, wherein application of the resolution transformation provides a second quantity, and further comprising:
absolute rule execution logic that executes any enabled absolute rules, with a corresponding absolute impact property, on the second quantity identifier to obtain the adjusted quantity identifier; and
absolute rule violation detector logic that determines whether the adjusted quantity identifier violates any enabled, absolute rules and, if so, surfaces an error indicator.
